(19) United States
(12) Patent Application Publication
(10) Pub. No.: US 2025/0286802 A1
(43) Pub. Date: Sep. 11, 2025

(54) DATA PROCESSING METHOD AND RELATED APPARATUS

(71) Applicant: TENCENT TECHNOLOGY (SHENZHEN) COMPANY LIMITED, Shenzhen (CN)

(72) Inventors: Xianneng ZOU, Shenzhen (CN); Yachen WANG, Shenzhen (CN); Wenkun LIN, Shenzhen (CN); Shengli ZHENG, Shenzhen (CN); Jiwu BU, Shenzhen (CN); Jin JIAO, Shenzhen (CN)

(73) Assignee: TENCENT TECHNOLOGY (SHENZHEN) COMPANY LIMITED, Shenzhen (CN)

(21) Appl. No.: 19/215,505

(22) Filed: May 22, 2025

Related U.S. Application Data
(63) Continuation of application No. PCT/CN2024/086289, filed on Apr. 7, 2024.

(30) Foreign Application Priority Data
Jun. 2, 2023 (CN) 202310649532.7

(51) Int. Cl. H04L 43/0876

(52) U.S. Cl. CPC H04L 43/0876

(57) ABSTRACT

A data processing method, apparatus, and computer-readable storage medium for efficient network traffic analysis. The method includes acquiring network traffic data, performing information extraction to obtain target information with reduced volume compared to the original data, and transmitting this target information to a traffic detection device to obtain detection results. For multiple pieces of network traffic data, the method can aggregate target information before transmission. The apparatus implements the method through memory storing program code and a processor executing the code. By processing extracted information rather than complete traffic data, the invention significantly improves efficiency of network traffic detection systems.

### CROSS-REFERENCE TO RELATED APPLICATIONS

This application is a continuation application of International Application No. PCT/CN2024/086289 filed on Apr. 7, 2024, which claims priority to Chinese Patent Application No. 202310649532.7 filed with the China National Intellectual Property Administration on Jun. 2, 2023, the disclosures of each being incorporated by reference herein in their entireties.

### FIELD

The disclosure relates to the technical field of data processing, and to data processing methods, apparatus, storage mediums, and program products.

### BACKGROUND

Network communication between devices may be realized based on a manner of transmitting network traffic. The network traffic may carry information used by the network communication, and the like. An example in which network communication between a first device and a second device is realized is used. A communication connection between the first device and the second device may be established based on a network. After the communication connection is established, the network communication between the first device and the second device may be realized by transmitting network traffic.

In network communication, for the purpose of ensuring network security, transmitted network traffic may be detected to find an abnormal case in time, such as abnormal network traffic and a traffic burst location, thereby facilitating ensuring network security. Based on the detection of network traffic, the resource occupation (for example, bandwidth occupation) in a network communication process may be analyzed, and excessively high resource occupation may be found in time to effectively avoid unstable network operation caused by excessively high resource occupation, thereby facilitating ensuring the normal and stable network operation.

### SUMMARY

Provided are a data processing method, apparatus, storage medium, and program product, which can efficiently process network traffic data by extracting and transmitting reduced-volume target information to a traffic detection device, thereby improving network traffic detection efficiency.

According to some embodiments, a data processing method, performed by a computer device, includes: acquiring network traffic data; performing information extraction on the network traffic data; obtaining target information corresponding to the network traffic data, a volume of the target information being less than a volume of the network traffic data; and transmitting the target information to a traffic detection device, and obtaining a detection result, from the traffic detection device, corresponding to the network traffic data.

According to some embodiments, a data processing apparatus includes: at least one memory configured to store program code; and at least one processor configured to read the program code and operate as instructed by the program code, the program code including: acquisition code configured to cause at least one of the at least one processor to acquire network traffic data; extraction code configured to cause at least one of the at least one processor to perform information extraction on the network traffic data; obtaining code configured to cause at least one of the at least one processor to obtain target information corresponding to the network traffic data, a volume of the target information being less than a volume of the network traffic data; and transmission code configured to cause at least one of the at least one processor to transmit the target information to a traffic detection device, and obtain a detection result, from the traffic detection device, corresponding to the network traffic data.

According to some embodiments, a non-transitory computer-readable storage medium, storing computer code which, when executed by at least one processor, causes the at least one processor to at least: acquire network traffic data; perform information extraction on the network traffic data; obtain target information corresponding to the network traffic data, a volume of the target information being less than a volume of the network traffic data; and transmit the target information to a traffic detection device, and obtain a detection result, from the traffic detection device, corresponding to the network traffic data.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a network traffic detection scene according to some embodiments.

FIG. 2 is a schematic diagram of an application scene of a data processing method according to some embodiments.

FIG. 3 is a flowchart of a data processing method according to some embodiments.

FIG. 4 is a schematic diagram of a microburst scene.

FIG. 5 is a schematic diagram of a non-microburst scene.

FIG. 6 is a schematic structural diagram of a binary tree according to some embodiments.

FIG. 7 is a schematic diagram of a system architecture of network traffic detection according to some embodiments.

FIG. 8 is a schematic diagram of processing logic of double mirroring according to some embodiments.

FIG. 9 is a schematic diagram of processing logic of multicast replication combined with single mirroring according to some embodiments.

FIG. 10 is a flowchart of another data processing method according to some embodiments.

FIG. 11 is a structural diagram of a data processing apparatus according to some embodiments.

FIG. 12 is a structural diagram of another data processing apparatus according to some embodiments.

FIG. 13 is a structural diagram of a terminal according to some embodiments.

FIG. 14 is a structural diagram of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In actual application, network communication between devices may be performed based on a manner of transmitting network traffic. The network traffic may carry information used by the network communication, and the like. For example, the network traffic may be a message. During network communication, for the purpose of ensuring network security, transmitted network traffic is detected to find an abnormal case in time, such as abnormal network traffic and a traffic burst location. The abnormal case is processed in time to ensure network security. The abnormal network traffic may refer to attack network traffic that affects network security. Based on network traffic detection, abnormal traffic may be found in time, and a source of the attack network traffic may be positioned, thereby facilitating ensuring network security.

Using a first device and a second device as an example, a communication connection between the first device and the second device may be established based on a network. After the communication connection is established, the network communication between the first device and the second device may be realized by transmitting network traffic. During the network communication between the first device and the second device, the transmitted network traffic may be detected, for example, a network traffic detection scene in the network communication. The first device and the second device are not limited. In actual application, the first device and the second device may be different in different network traffic detection scenes. For example, for a network traffic detection scene in a carrier-grade network, the first device may be a data access terminal (for example, a user terminal), and the second device may be a business processing terminal (for example, a network business provider).

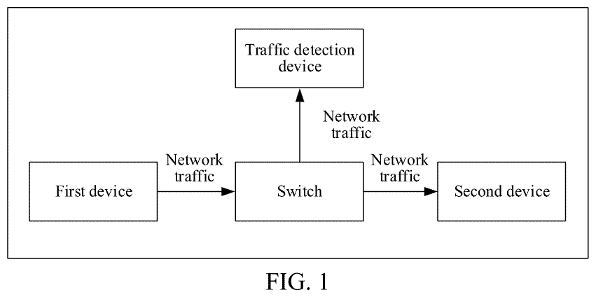

For ease of understanding, the network traffic detection scene may refer to FIG. 1. FIG. 1 is a schematic diagram of a network traffic detection scene according to some embodiments. In FIG. 1, an example in which network traffic transmitted by the first device to the second device is detected is used, and this is not limited. In actual application, network traffic transmitted by the second device to the first device may be detected. A communication connection between the first device and the second device may be established based on a network. In actual application, the network traffic transmitted by the first device to the second device may be distributed to the second device via a switch. Network traffic that is to be detected may be transmitted to a traffic detection device via a switch. The traffic detection device may detect received network traffic. The traffic detection device may complete the detection by analyzing information carried in the network traffic. A communication connection between the first device and the switch may be established based on a network, and a communication connection between the second device and the switch may be established based on a network. The communication connection between the first device and the second device may be an indirect connection established through the switch. A communication connection between the traffic detection device and the switch may be established based on a network.

When network traffic detection is performed, the switch may transmit the full volume of network traffic that is to be detected to the traffic detection device, for example, transmitting all information carried in the network traffic to the traffic detection device. Transmitting the network traffic to the traffic detection device may consume a particular bandwidth. For network traffic detection, the traffic detection device may complete detection on the network traffic using some information carried in the network traffic to determine whether there is an abnormality. For example, only some of the information carried in the network traffic is effective information for network traffic detection. It can be learned that for network traffic detection, the bandwidth cost in this manner is relatively high.

Some embodiments provide a data processing method and a related apparatus. For the network traffic detection scene, before network traffic is transmitted to the traffic detection device, effective information for network traffic detection is extracted so that only the effective information may be transmitted to the traffic detection device. Since the effective information is information used during network traffic detection, the traffic detection device may detect the effective information to realize detection. Since a data volume of the effective information is less than a data volume of the network traffic, a bandwidth cost for transmitting the effective information to the traffic detection device is less than a bandwidth cost for transmitting the network traffic so that the bandwidth cost can be reduced based on detecting the network traffic.

The data processing method provided in some embodiments may be implemented through a computer device. The computer device may be a terminal or a server. The server may be an independent physical server, a server cluster or a distributed system including a plurality of physical servers, or a cloud server providing a cloud computing service. The terminal includes, but is not limited to a smartphone, a computer, an intelligent voice interaction device, an intelligent household appliance, an in-vehicle terminal, and the like. The terminal and the server may be directly or indirectly connected in a wired or wireless communication manner. The disclosure is not limited thereto. Some embodiments may be applied to various scenes, including but not limited to, cloud technology, artificial intelligence (AI), intelligent transportation, audio and video, assisted driving, and the like. Some embodiments may be applied to various network traffic detection scenes, for example, a network traffic detection scene in a carrier-grade network and a network traffic detection scene in an enterprise network.

In some embodiments, user information and other relevant data may be involved during data processing. When the embodiments are applied to products or technologies, the user's separate consent or separate permission should be obtained, and acquisition, use, and processing of relevant data should comply with relevant laws, regulations, and standards of relevant countries and regions.

The method provided in some embodiments may relate to AI technology. AI involves a theory, a method, a technology, and an application system that use a digital computer or a machine controlled by the digital computer to simulate, extend, and expand human intelligence, perceive an environment, acquire knowledge, and use knowledge to obtain an optimal result. For example, in some embodiments, automatic execution of the data processing method may be implemented using AI.

The AI technology is a comprehensive discipline and relates to a wide range of fields including hardware-level technologies and software-level technologies. AI technologies include technologies such as a sensor, a dedicated AI chip, cloud computing, distributed storage, a big data processing technology, an operating/interaction system, and electromechanical integration. AI software technologies include several major directions such as a computer vision technology, a speech processing technology, a nature language processing technology, machine learning/deep learning, automatic driving, and intelligent transportation. Some embodiments may relate to machine learning. For example, for acquired to-be-detected network traffic, information extraction may be automatically performed using machine learning, and target information obtained by information extraction may be automatically transmitted to the traffic detection device, thereby facilitating improving the data processing efficiency.

Cloud computing is a computing mode, in which computing tasks are distributed on a resource pool including many computers so that various application systems can acquire computing power, storage space, and information services according to requirements. A network providing a resource is referred to as a “cloud”. For a user, resources in the “cloud” seem to be infinitely expandable, and may be acquired readily, used on demand, expanded readily, and paid for use. As a capability provider of cloud computing, a cloud computing resource pool (briefly referred to as a cloud platform, and referred to as an infrastructure as a service (IaaS) platform) is established, and multiple types of virtual resources are deployed in the resource pool, for an external customer to select and use. For example, in some embodiments, the resource in the “cloud” may be network traffic. Network communication is realized by transmitting the network traffic, and detection may be performed by acquiring the network traffic, to find an abnormal case in time.

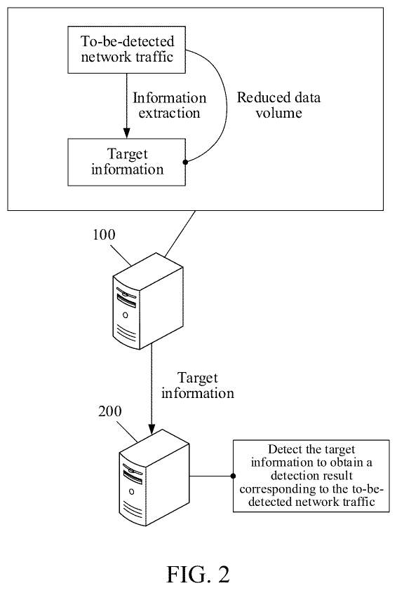

FIG. 2 is a schematic diagram of an application scene of a data processing method according to some embodiments. In the scene shown in FIG. 2, a switch 100 and a traffic detection device 200 may be included. A communication connection is provided between the switch 100 and the traffic detection device 200. The switch 100 and the traffic detection device 200 shown in FIG. 2 are examples and are not limited thereto. The following describes, with reference to the scene shown in FIG. 2, an example in which the switch 100 is used as the foregoing computer device.

When network traffic is to be detected, the switch 100 may acquire to-be-detected network traffic. The to-be-detected network traffic may refer to network traffic configured for detection. In actual application, using the foregoing network traffic detection scene when the first device transmits network traffic to the second device as an example, the to-be-detected network traffic may be determined based on the network traffic transmitted by the first device to the second device, and detection on the network traffic transmitted by the first device to the second device may be completed based on detection on the to-be-detected network traffic.

For the acquired to-be-detected network traffic, the switch 100 may perform information extraction on the to-be-detected network traffic to obtain target information corresponding to the to-be-detected network traffic. The target information may refer to information for detecting the to-be-detected network traffic, for example, the target information is effective information for detection.

After the target information is obtained, the switch 100 may transmit the target information to the traffic detection device 200, and the traffic detection device 200 may detect the target information. Since the target information is effective information for detection, the traffic detection device 200 may detect the target information to obtain a detection result corresponding to the to-be-detected network traffic, thereby realizing detection.

A data volume of the target information is less than a data volume of the to-be-detected network traffic. For example, the data volume of the network traffic may be reduced through information extraction so that a bandwidth cost used by the switch 100 for transmitting the target information to the traffic detection device 200 is less than a bandwidth cost for transmitting the to-be-detected network traffic. The target information is effective information for detection. The bandwidth cost can be reduced based on detecting the network traffic.

The configuration of the switch 100 is not limited in some embodiments. In actual application, for ease of implementing the data processing method provided in some embodiments, the switch 100 may be configured as a programmable switch. While forwarding the network traffic, the programmable switch has a programmable feature. Based on the programmable feature, a procedure of processing the network traffic may be self-defined, facilitating implementation of the data processing method provided in some embodiments.

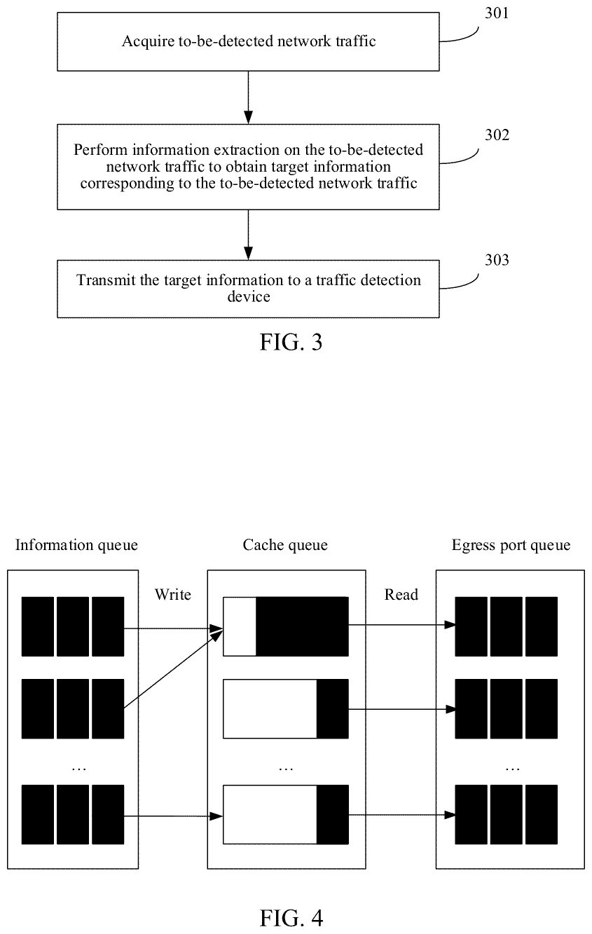

FIG. 3 is a flowchart of a data processing method according to some embodiments. An example in which a switch is used as the foregoing computer device is used for description. The method includes operations 301 to 303.

Operation 301: Acquire to-be-detected network traffic.

When network traffic is to be detected, the switch may acquire to-be-detected network traffic. The to-be-detected network traffic may refer to network traffic configured for detection. In actual application, using the foregoing network traffic detection scene when the first device transmits network traffic to the second device as an example, the to-be-detected network traffic may be determined based on the network traffic transmitted by the first device to the second device, and detection on the network traffic transmitted by the first device to the second device may be completed based on detection on the to-be-detected network traffic.

The to-be-detected network traffic is not limited. For ease of understanding. the to-be-detected network traffic is described from the following three aspects in some embodiments.

In a first aspect, a relationship between the to-be-detected network traffic and the network traffic transmitted between the devices is not limited. The to-be-detected network traffic may refer to network traffic configured for detection, and the detection aims to ensure network security and the like. The network traffic transmitted between the devices may refer to network traffic configured for network communication, and the network traffic is transmitted to perform network communication. A change of information carried in the network traffic may affect network communication. To avoid network communication being affected by network traffic detection, network traffic detection may be performed based on network traffic obtained by replicating the network traffic configured for network communication. For example, the to-be-detected network traffic may be obtained by replicating the network traffic configured for network communication. The network traffic configured for network communication may refer to network traffic transmitted during network communication between devices. For example, the to-be-detected network traffic may be obtained by replicating network traffic transmitted by the first device to the second device. Detection does not change the network traffic transmitted by the first device to the second device, thereby avoiding affecting network communication.

In another aspect, the type of the to-be-detected network traffic is not limited. For example, in actual network communication, an example in which the network traffic transmitted between devices is a message is used. Correspondingly, the type of the to-be-detected network traffic may be in the form of a message.

In another aspect, the quantity of the to-be-detected network traffic is not limited. In an actual network traffic detection scene, a volume of network traffic transmitted between devices may be large. Correspondingly, there may be a plurality of pieces of to-be-detected network traffic.

Operation 302: Perform information extraction on the to-be-detected network traffic to obtain target information corresponding to the to-be-detected network traffic.

After acquiring the to-be-detected network traffic, the switch may perform information extraction on the to-be-detected network traffic to obtain the target information corresponding to the to-be-detected network traffic. The target information may refer to information for detecting the to-be-detected network traffic, for example, the target information is effective information for detection. Under different detection objectives, information for detection may be different.

Since the target information is configured for detection, when extracting the target information from the to-be-detected network traffic, the switch may not extract information unrelated to detection from the to-be-detected network traffic, thereby effectively reducing a data volume of the target information. The data volume of the target information is less than a data volume of the to-be-detected network traffic. The data volume can be reduced through information extraction.

The manner of information extraction is not limited. In actual application, different types of the to-be-detected network traffic may lead to different information extraction manners. For ease of understanding, in some embodiments, an example in which the type of the to-be-detected network traffic is a message is used, and the following manner is provided as an example.

When the type of the to-be-detected network traffic is in the form of a message, the to-be-detected network traffic may be referred to as a to-be-detected message. The to-be-detected message may include a plurality of fields, and different fields may carry different information. In some embodiments, the manner of information extraction may be extracting relevant fields carrying effective information (relative to detection) in the to-be-detected message, thereby extracting the effective information. For example, the plurality of fields of the to-be-detected message may carry message five-tuple information, message length information, message version information, and the like. The message five-tuple information may include a source Internet protocol address (IP address), a destination IP address, a source port number, a destination port number, and a protocol type of the to-be-detected message. An example in which the first device transmits network traffic to the second device is used. The source IP address may refer to an IP address of the first device, the destination IP address may refer to an IP address of the second device, the source port number may refer to a device port number of the first device, the destination port number may refer to a device port number of the second device, and the protocol type may be a protocol adopted by the to-be-detected message. For example, the adopted protocol may be a transmission control protocol (TCP) or a user datagram protocol (UDP). The message length information may identify a length of the to-be-detected message, and the message version information may identify a version of the to-be-detected message. For detection, the message five-tuple information and the message length information can be configured for detecting whether an IP address is legal and valid, and detecting whether the length of the to-be-detected message is abnormal, to evaluate whether the to-be-detected message is abnormal (for example, the IP address is illegal and invalid, indicating possible attack network traffic described above). In actual application, the message five-tuple information and the message length information may be determined as effective information related to this detection, and during information extraction, related fields carrying the message five-tuple information and the message length information may be extracted.

Corresponding to a case where the to-be-detected network traffic is the to-be-detected message, to facilitate subsequent transmission of the target information, after the message five-tuple information and the message length information are extracted, the information may be recombined so that the type of effective information still conforms to the form of the message, thereby facilitating subsequent transmission.

The form of the data volume is not limited. The data volume may be configured for characterizing a data size. For example, the data volume of the target information is configured for characterizing a data size of the target information, and the data volume of the to-be-detected network traffic is configured for characterizing a data size of the to-be-detected network traffic. In actual application, the data volume may be in the form of a data length in byte (B), kilobyte (KB), or the like, which can intuitively characterize the data size. For example, the data volume of the to-be-detected network traffic may be 512 B, the effective information is information of 40B, and correspondingly, the data volume of the target information may be 40 B.

Operation 303: Transmit the target information to a traffic detection device.

After obtaining the target information, the switch may transmit the target information to the traffic detection device, and the traffic detection device may be configured to detect the target information. Since the target information is effective information for detection, the traffic detection device may detect the target information to obtain a detection result corresponding to the to-be-detected network traffic, thereby realizing detection. Since the data volume of the target information is less than the data volume of the to-be-detected network traffic, a smaller data volume indicates a lower bandwidth cost for transmitting between devices. The data volume is reduced through information extraction so that a bandwidth cost used by the switch for transmitting the target information to the traffic detection device is less than a bandwidth cost for transmitting the to-be-detected network traffic. Information extracted through information extraction is effective information for detection. The bandwidth cost may be reduced while ensuring the detection accuracy. The foregoing example in which the to-be-detected network traffic is the to-be-detected message is used. Based on information extraction, relevant fields carrying effective information are reserved, and other fields are filtered, thereby reducing a field length of the message and reducing the bandwidth cost.

The manner of transmitting the target information to the traffic detection device is not limited. In most network traffic detection scenes, the volume of network traffic transmitted between devices may be large. Correspondingly, there may be a plurality of pieces of to-be-detected network traffic. For better understanding, in some embodiments, an example in which the to-be-detected network traffic may include n pieces of to-be-detected network traffic, n being an integer greater than 1 is used, and the following manner is provided as an example.

In an actual network traffic detection scene, for target information corresponding to the n pieces of to-be-detected network traffic, in some embodiments, the switch may directly transmit the target information corresponding to the n pieces of to-be-detected network traffic to the traffic detection device. According to this manner, the traffic detection device may receive n pieces of target information corresponding to the n pieces of to-be-detected network traffic, respectively. Correspondingly, the traffic detection device may detect the n pieces of target information to obtain detection results corresponding to the n pieces of to-be-detected network traffic. The traffic detection device may detect the n pieces of to-be-detected network traffic by performing detection for n times to obtain the detection results corresponding to the to-be-detected network traffic. In this manner, n detection results may be obtained, which is more intuitive. In the manner of directly transmitting the target information corresponding to the n pieces of to-be-detected network traffic to the traffic detection device, the switch does not perform other processing on the n pieces of target information, but directly transmits the target information to the traffic detection device. This manner may be referred to as a normal mirror-based transmission manner.

Detecting the target information by the traffic detection device may consume device performance of the traffic detection device. In actual application, detection performed by the traffic detection device for more times has a greater requirement on the device performance of the traffic detection device. In some embodiments, the switch may first aggregate the target information corresponding to the n pieces of to-be-detected network traffic before transmitting the target information. The aggregation may be a processing manner of aggregating a plurality of pieces of target information to one piece of aggregation information. The switch may transmit the aggregation information obtained through aggregation to the traffic detection device, thereby transmitting the plurality of pieces of target information to the traffic detection device. Correspondingly, the traffic detection device may detect the aggregation information, thereby detecting the plurality of pieces of target information. Detection on the plurality of to-be-detected network traffic may be completed through one detection, thereby reducing the number of times of detection, and facilitating reducing the loss of the device performance of the traffic detection device. In some embodiments, the switch may aggregate the target information corresponding to the n pieces of to-be-detected network traffic, and then transmit the aggregation information obtained through aggregation to the traffic detection device. Correspondingly, the traffic detection device may be configured to detect the received aggregation information to obtain a detection result. Through aggregation, the number of times of detection performed by the traffic detection device can be effectively reduced, thereby reducing the loss of the device performance of the traffic detection device.

The manner of first aggregating and then transmitting the aggregation information obtained through aggregation may be referred to as a collescing mirror-based transmission manner. When the collescing mirror-based transmission manner is adopted, the data processing method provided in some embodiments may be considered as a method of compressing the data volume based on information extraction and aggregating a plurality of pieces of target information to one piece of aggregation information based on aggregation, thereby reducing the number of times of detection. For a network traffic detection scene in which the volume of the network traffic may be large, the bandwidth cost and the loss of the device performance of the traffic detection device can be greatly reduced. This method is a high-performance network traffic detection technology. The foregoing example in which the to-be-detected network traffic is a message is used. The target information may be in a message form, and the aggregation information may be message information. After this application is adopted, a plurality of messages may be compressed and aggregated into the same message for detection.

In the collescing mirror-based transmission manner, the manner of aggregating the target information corresponding to the n pieces of to-be-detected network traffic is not limited. In actual application, the objective of aggregation is to determine a plurality of pieces of target information as one piece of aggregation information. In some embodiments, a manner of aggregation may be splicing, for example, a plurality of pieces of target information may be spliced together to obtain one piece of aggregation information. In actual application, pieces of target information may be flexibly set to be aggregated into one piece of aggregation information. Correspondingly, when the target information corresponding to the n pieces of to-be-detected network traffic is aggregated, each time a sufficient amount of target information is generated, aggregation may be performed to obtain one piece of aggregation information. For example, the target information corresponding to the n pieces of to-be-detected network traffic may be aggregated to obtain a plurality of pieces of aggregation information.

Corresponding to the collescing mirror-based transmission manner, a plurality of pieces of target information is aggregated into one piece of aggregation information. For ease of aggregation, the target information corresponding to the n pieces of to-be-detected network traffic may further be first cached and stored, and then aggregated subsequently. In actual application, cache addresses may be configured in the switch. The cache address may refer to storage space having a cache storage capability. In the switch, the cache address may be a session control object. The target information corresponding to the n pieces of to-be-detected network traffic may be cached and stored using the cache address. In some embodiments, before aggregating the target information corresponding to the n pieces of to-be-detected network traffic, the switch may write the target information corresponding to the n pieces of to-be-detected network traffic into the cache addresses. The target information corresponding to the n pieces of to-be-detected network traffic is cached and stored. Correspondingly, the foregoing implementation of aggregating the target information corresponding to the n pieces of to-be-detected network traffic may include the following operations. The switch may aggregate the target information corresponding to the n pieces of to-be-detected network traffic written into the cache addresses. The foregoing implementation of transmitting the aggregation information obtained through aggregation to the traffic detection device may include the following operations. The switch may read the aggregation information obtained through aggregation from the cache address, and then transmit the read aggregation information to the traffic detection device. The target information corresponding to a plurality of pieces of to-be-detected network traffic may be cached and stored using the cache addresses, and then aggregated and transmitted.

The manner of writing the target information corresponding to the n pieces of to-be-detected network traffic into the cache addresses is not limited. Manners of writing into the cache address are different, and manners of aggregating the target information corresponding to the n pieces of to-be-detected network traffic written into the cache addresses may further be different. In actual application, the foregoing cache address may include a plurality of cache addresses. The foregoing n pieces of target information may be cached and stored using the plurality of cache addresses. For ease of understanding, an example in which the cache addresses include a plurality of cache addresses is used for description below.

In actual application, one of functions of the switch may be forwarding received information. For ease of forwarding, a data packet transmission manner is provided. The received information is cached and stored using the cache address, and the information is read from the cache address and forwarded. An information queue, a cache queue, and an egress port queue may be included. The information queue may include the received information. The cache queue may include a plurality of cache addresses. The egress port queue may include information read from the cache address. The read information may be forwarded via an egress port of the switch.

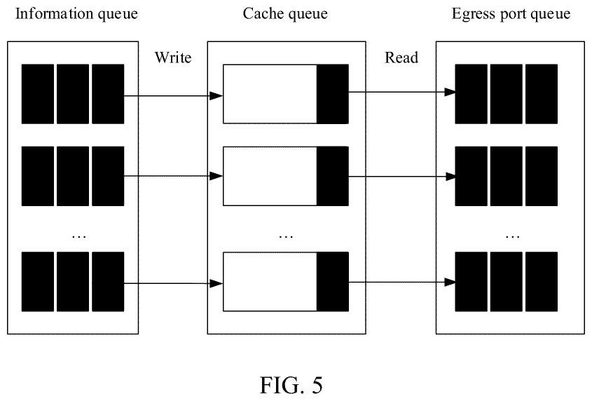

For any cache address in the plurality of cache addresses, processing in writing and reading directions may be included. In actual application, a cache write rate may be adopted to represent a rate at which information in the information queue is written to the cache address, and a cache read rate may be adopted to represent a rate at which information in the cache queue is read to the egress port queue. The cache read rate may depend on a processing rate of the egress port queue. If the cache write rate is greater than the cache read rate, continuous accumulation of cache writing may occur. For example, in a case that the cache address is already full, the cache write rate is greater than the cache read rate, and continuous accumulation may occur. This case may be referred to as a microburst scene, as shown in FIG. 4. FIG. 4 is a schematic diagram of a microburst scene. The foregoing information queue, cache queue, and egress port queue may be included. Using a first cache address in a plurality of cache addresses as an example, the cache write rate may be considered as two write operations per unit time, and the cache read rate may be considered as one read operation per unit time. Since the first cache address does not have sufficient cache space, information packet loss may be caused. For example, after a microburst is generated, a packet loss problem is generated due to insufficient caching. If the cache write rate is equal to the cache read rate, the foregoing case of continuous accumulation of cache writing does not occur, for example, no microburst is generated. This case may refer to FIG. 5. FIG. 5 is a schematic diagram of a non-microburst scene. A cache write rate is equal to a cache read rate. A microburst does not occur.

If the data packet transmission manner provided is used, the n pieces of target information in some embodiments are written into cache addresses. The microburst case shown in FIG. 4 may occur. In actual application, since cache space of a chip of a switch may be relatively small, correspondingly, cache space allocated to a single cache address in the switch may be relatively small. A single cache address corresponds to one cache pipeline, and a plurality of cache addresses may correspond to a plurality of cache pipelines. For example, a chip of a programmable switch may be an application integrated circuit (ASIC) chip, and correspondingly, cache space allocated to a single cache address may be 122 KB. Small cache space is more prone to microbursts, and insufficient cache often causes packet loss of the target information. The detection accuracy is reduced.

Even if there is no microburst, for example, the case shown in FIG. 5, since in some embodiments, the main objective of writing the n pieces of target information into the cache addresses is to facilitate aggregating a plurality of pieces of target information into one piece of aggregation information, for any cache address, obtaining one piece of aggregation information through aggregation can be satisfied only after a sufficient amount of target information is written, and the aggregation information can be read and transmitted subsequently. If a sufficient amount of target information cannot be written, obtaining one piece of aggregation information through aggregation cannot be achieved. Through another manner, a plurality of cache addresses almost simultaneously satisfies writing of a sufficient amount of target information. Before satisfying the condition, each cache address has cache occupancy, but aggregation information cannot be obtained, leading to relatively low aggregation performance.

It can be learned that no matter whether a microburst occurs or not, the data packet transmission in the other manner cannot satisfy high-performance aggregation, and the detection accuracy may further be affected by the microburst.

Some embodiments provide another data packet transmission manner. For n pieces of target information, the target information may be continuously written into one cache address in a plurality of cache addresses until the cache address cannot be continuously written into, and the target information is written into a next cache address until the n pieces of target information is completely written into the cache addresses. A sufficient amount of target information may be preferentially written into one cache address so that aggregation may be performed to obtain one piece of aggregation information, thereby facilitating improving the aggregation performance. The target information is preferentially written into a cache address until the cache address cannot be continuously written into, and the target information is written into a next cache address so that the cache occupation may be reduced. In actual application, a reason why writing into the current cache address cannot be continued may be that the remaining cache capacity of the current cache address is insufficient to store the target information. It can be ensured that writing into a cache address with insufficient cache cannot be performed, thereby avoiding the occurrence of a microburst, avoiding a packet loss problem, and facilitating ensuring the detection accuracy. In some embodiments, for each of the n pieces of target information, whether to continue to be written into the current cache address or to be written into a next cache address may be determined in sequence.

In actual application, for any cache address in the plurality of cache addresses, a cache capability of the cache address may represent a data volume that can be stored. For ease of determining whether the remaining cache capability of the current cache address is sufficient to store the target information, an example in which the data volume is the foregoing data length is used for description, and a remaining cache length may be adopted to represent the remaining cache capability of the cache address. Correspondingly, in a process of writing into the cache address, some embodiments of determining whether to continue to write into the current cache address or to write into a next cache address may be determined based on comparing a data length corresponding to a data volume of the target information with a remaining cache length of the current cache address. If the remaining cache length is greater than or equal to the data length corresponding to the data volume of the target information, the remaining cache capacity of the cache address can store the target information. The target information may be continuously written into the current cache address. Correspondingly, if the remaining cache length is less than the data length corresponding to the data volume of the target information, the remaining cache capacity of the cache address is insufficient to store the target information. The target information may be written into a next cache address.

Correspondingly, in the foregoing implementation of aggregating the target information corresponding to the n pieces of to-be-detected network traffic written into the cache address, when the current cache address is insufficient to continue to store the target information, the storage of the current cache address reaches an upper limit (for example, full storage). Target information stored in the current cache address may begin to be aggregated, and aggregation information obtained through aggregation is transmitted to the traffic detection device for detection until the target information corresponding to the n pieces of to-be-detected network traffic is completely aggregated. Writing and detection may be performed simultaneously, which is more efficient.

For better understanding, some embodiments is described using an example in which the plurality of cache addresses may include two cache addresses, which may include a first cache address and a second cache address, and an example in which the data volume is the foregoing data length.

In actual application, the target information is effective information for detection. The data volume of the target information may be fixed. The data volume of the target information may be a preset data length, and the preset data length may be, for example, the foregoing 40B. When the target information is written into the cache address, the first cache address may be the foregoing current cache address, and the second cache address may be the foregoing next cache address. In some embodiments, for an i-th piece of target information corresponding to an i-th piece of to-be-detected network traffic in the n pieces of to-be-detected network traffic, if it is determined that a remaining cache length of the first cache address is greater than or equal to the preset data length, the first cache address is sufficient to store the i-th piece of target information. The i-th piece of target information may be written into the first cache address. i is an integer greater than or equal to 2 and less than or equal to n. Since the first cache address may be the current cache address, the first cache address may store an (i−1)-th piece of target information corresponding to an (i−1)-th piece of to-be-detected network traffic in the n pieces of to-be-detected network traffic. If it is determined that the remaining cache length of the first cache address is less than the preset data length, the first cache address is insufficient to store the i-th piece of target information. The i-th piece of target information may be written into the second cache address. Finally, n pieces of target information corresponding to the n pieces of to-be-detected network traffic are completely written into the cache addresses. The target information is first written into the first cache address, and when the first cache address cannot continue to be written into, the target information is written into the second cache address so that the storage of a sufficient amount of target information can be more quickly satisfied to obtain one piece of aggregation information through aggregation, thereby facilitating reducing the cache occupation and improving the aggregation performance. The target information is not written into a cache address with insufficient cache to avoid the occurrence of a microburst and avoid packet loss, thereby facilitating ensuring the detection accuracy.

The manner of determining the remaining cache length of the first cache address is not limited. In actual application, for any cache address, there is an upper limit on its caching capability, for example, a maximum data volume that can be stored. This may be represented using a maximum cache length of the cache address. In a process of information storage of the cache address, a historical cache length may further be adopted to represent a sum of data lengths of information already stored in the cache address. In this manner, the remaining cache length may be determined using a difference between the maximum cache length and the historical cache length. Corresponding to the first cache address, the remaining cache length of the first cache address may be a difference between a maximum cache length and a historical cache length of the first cache address.

To better understand the foregoing implementation of aggregating the target information corresponding to the n pieces of to-be-detected network traffic written into the cache addresses, the first cache address and the second cache address are still used as an example for description.

In actual application, starting to read information from the cache address may be performed after the cache address is full. For example, reading may not be temporarily performed before the cache address is full, and reading is performed only after the cache address is full. When n pieces of target information are stored using the first cache address and the second cache address, to improve the storage efficiency of the first cache address, the maximum cache length of the first cache address may include m preset data lengths, m being an integer greater than 1. For example, the first cache address can store just m pieces of target information. The second cache address is similar. The first cache address and the second cache address may be configured with the same maximum cache length. Correspondingly, when it is determined that the target information cannot be stored in the first cache address, it may be considered that the first cache address is full. M pieces of target information stored in the first cache address may be aggregated, and aggregation information obtained through aggregation is read from the first cache address, to transmit the read aggregation information to the traffic detection device. The target information may be written into the second cache address. After the second cache address is full, m pieces of target information stored in the second cache address may further be aggregated, and aggregation information obtained through aggregation is read from the second cache address, to transmit the read aggregation information to the traffic detection device. The rest may be deduced by analogy until the target information corresponding to the n pieces of to-be-detected network traffic is completely aggregated.

In some embodiments, in a process of writing the n pieces of to-be-detected network traffic into the cache addresses, the switch may determine a cache address that stores m pieces of target information among the first cache address and the second cache address as a target cache address, for example, determining a cache address that is already full as the target cache address. The target cache address is full, and reading may be performed. Aggregation may be performed based on the m pieces of target information stored in the target cache address, and the aggregation information obtained through aggregation may be read from the target cache address and transmitted to the traffic detection device, thereby facilitating detection. After the aggregation information is read, the target cache address may change from full storage to non-full storage, and subsequently, the target information may continue to be written. The rest may be deduced by analogy until the target information corresponding to the n pieces of to-be-detected network traffic is completely aggregated.

The manner of determining a magnitude relationship between the remaining cache length of the first cache address and the preset data length is not limited. For ease of understanding, in some embodiments, an example in which the maximum cache length of the first cache address may include m preset data lengths, m being an integer greater than 1 is used, and the following manner is provided as an example.

Since the first cache address can store just m pieces of target information, in some embodiments, determining may be performed based on the quantity of storage. In some embodiments, if i≤m, m pieces of target information have not been stored in the first cache address. It may be determined that the remaining cache length of the first cache address is greater than or equal to the preset data length. If i>m, m pieces of target information are already stored in the first cache address. It may be determined that the remaining cache length of the first cache address is less than the preset data length. Determining may be performed based on the quantity of storage, which is relatively simple.

In actual application, the problem of determining whether to continue to write into the first cache address or to write into the second cache address may be abstracted into a structure of a binary tree. In the binary tree, each parent node may correspond to two child nodes, and the two child nodes correspond to two cache addresses, respectively. After receiving the target information, the parent node may write the target information into a cache address corresponding to the child node in a manner of controlling which child node is adopted to transmit the target information. In some embodiments, determining and writing may be implemented using the structure of the binary tree. In the binary tree, the first cache address may correspond to a first child node, the second cache address may correspond to a second child node, and the first child node and the second child node correspond to the same parent node. The parent node is a node that receives the i-th piece of target information among nodes included in the binary tree. In the binary tree, a maximum cache length of the first child node may be adopted to represent an upper length limit of target information transmitted by the parent node through the first child node, and a length of historical information transmitted by the parent node through the first child node may be adopted to represent a length of target information that has been transmitted by the parent node through the first child node. The second child node is similar. The maximum cache length of the first child node may be determined according to the number of layers of the parent node in the binary tree and the maximum cache length of the first cache address. The upper length limit of the target information transmitted through the first child node matches the maximum cache length of the first cache address. The length of the historical information transmitted through the first child node may reflect a length of the first cache address that has been stored. Determining may be implemented using a magnitude relationship between the maximum cache length of the first child node and the historical information length of the first child node. The maximum cache length of the first cache address may include m preset data lengths, m being an integer greater than 1. Whether the first cache address corresponding to the first child node stores m pieces of target information may be determined using the magnitude relationship between the maximum cache length of the first child node and the historical information length of the first child node. In actual application, since the maximum cache length of the first child node may include an integer number of preset data lengths, the number may be determined based on the number of layers of the parent node in the binary tree and m, and may be an integer multiple of m.

If the length of the historical information transmitted by the parent node through the first child node is less than the maximum cache length of the first child node, the target information may still be transmitted through the first child node, the first cache address is not full, and the target information may continue to be stored. It may be determined that the remaining cache length of the first cache address is greater than or equal to the preset data length. The i-th piece of target information may be transmitted to the first child node using the parent node, and then written into the first cache address through the first child node. Correspondingly, if the length of the historical information transmitted by the parent node through the first child node is equal to the maximum cache length of the first child node, the upper limit is reached, and the first cache address is full. It may be determined that the remaining cache length of the first cache address is less than the preset data length. The i-th piece of target information may be transmitted to the second child node using the parent node, and then written into the second cache address through the second child node. The target information may be written into the cache addresses using the structure of the binary tree. In the binary tree, for ease of determining, each parent node may record lengths of historical information transmitted using two child nodes. A child node to which current target information belongs may be quickly determined. If the target information belongs to different child nodes, corresponding cache addresses to be written are different.

Based on the structure of the binary tree, the parent node does not transmit the target information using a child node that reaches the upper limit, thereby ensuring that the target information is not written into a full cache address, and avoiding the generation of a microburst. Before a child node reaches the upper limit, the child node is continuously adopted to transmit the target information so that the target information is preferentially written into the same cache address, thereby reducing the cache occupation and improving the aggregation performance.

The manner of implementing the structure of the binary tree is not limited. In actual application, a register in the switch may be configured to control transmitting information to a cache address. The structure of the binary tree may be implemented using the register in the switch. Since the structure of the binary tree includes a plurality of layers such as a parent node and a child node, in some embodiments, the structure of the binary tree may be implemented using the multi-level register control in the switch.

In the structure of the binary tree, a depth of the binary tree may refer to the number of layers on which a deepest node of all nodes included in the binary tree is located, or may refer to the number of layers on which a root node is located. In actual application, the depth of the binary tree varies with the number of cache addresses. A relationship between the depth of the binary tree and the number of cache addresses may be represented through the following formula:

A=log₂(B),
where A may represent the depth of the binary tree, and B may represent the number of cache addresses.

For example, the foregoing example in which the number of cache addresses is two, including the first cache address and the second cache address is still used. The depth of the binary tree is 1, for example, the number of layers of the root node in the binary tree is 1.

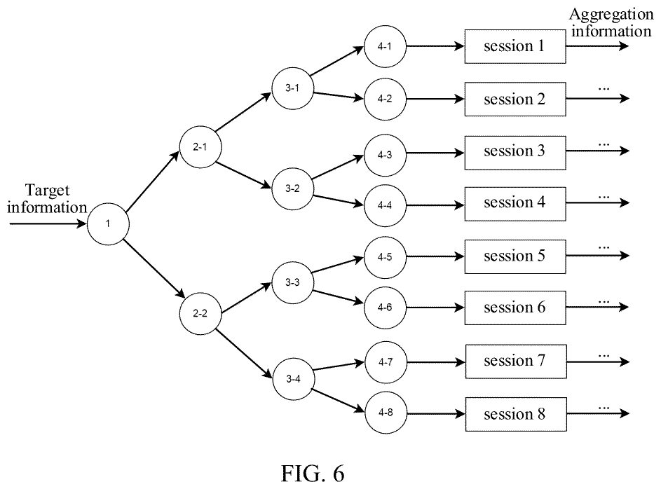

For ease of understanding, some embodiments provides a structure of a binary tree using an example in which the cache address is the foregoing session and an example in which the number of cache addresses is greater than two, including eight, as shown in FIG. 6. FIG. 6 is a schematic structural diagram of a binary tree. The eight cache addresses may be session 1, session 2, session 3, session 4, session 5, session 6, session 7, and session 8, respectively, corresponding to child nodes 4-1, 4-2, 4-3, 4-4, 4-5, 4-6, 4-7, and 4-8. A parent node corresponding to 4-1 and 4-2 is 3-1, a parent node corresponding to 4-3 and 4-4 is 3-2, a parent node corresponding to 4-5 and 4-6 is 3-3, and a parent node corresponding to 4-7 and 4-8 is 3-4. A parent node corresponding to 3-1 and 3-2 is 2-1, and a parent node corresponding to 3-3 and 3-4 is 2-2. A parent node corresponding to 2-1 and 2-2 is 1. The node 1 may be a deepest node in the binary tree. Corresponding to B=8, the depth A of the binary tree=3. Correspondingly, the number of layers of the node 1 in the binary tree is 3. The rest may be deduced by analogy. The number of layers of the nodes 2-1 and 2-2 in the binary tree is 2, the number of layers of the nodes 3-1, 3-2, 3-3, and 3-4 in the binary tree is 1, and the number of layers of the nodes 4-1, 4-2, 4-3, 4-4, 4-5, 4-6, 4-7, and 4-8 in the binary tree is 0, which are nodes directly corresponding to sessions.

For better understanding, a maximum cache length of each session may be recorded as max_buffer, and max_buffer may be equal to m preset data lengths. Based on the structure of the binary tree shown in FIG. 6, it can be learned that the maximum cache length of the node 4-1 may be equal to max_buffer, and the maximum cache length corresponding to each of the nodes 4-2, . . . , 4-7, and 4-8 may be equal to max_buffer. The maximum cache length of the node 3-1 may be a sum of the maximum cache lengths of the child nodes 4-1 and 4-2 corresponding to the node 3-1, and may be equal to 2*max_buffer. The nodes 3-2, 3-3, and 3-4 are similar. The maximum cache length of the node 2-1 may be a sum of the maximum cache lengths of the child nodes 3-1 and 3-2 corresponding to the node 2-1, and may be equal to 4*max_buffer. The node 2-2 is similar. The maximum cache length of the node 1 may be a sum of the maximum cache lengths of the child nodes 2-1 and 2-2 corresponding to the node 1, and may be equal to 8*max_buffer. Since the node 1 is the root node, any piece of target information may reach the node 1 first and then is transmitted via the node 1.

It can be learned that based on the structure of the binary tree shown in FIG. 6, the maximum cache length of any child node may be determined according to the number of layers of the parent node corresponding to the child node in the binary tree and the maximum cache length of the session corresponding to the child node. The maximum cache length may be represented through the following formula:

$$max\_node = {2}^{a - 1} * max\_buffer ,$$

where max_node may represent the maximum cache length of any child node, a may represent the number of layers of the parent node corresponding to the child node in the binary tree, and max_buffer may represent the maximum cache length of the session corresponding to the child node.

According to the data packet transmission manner provided in some embodiments, since the target information is not written into a full session, it can be ensured that no microburst scene occurs, so that this application is not affected by a microburst. The cache occupation can be reduced. If the other data packet transmission manner is adopted, a plurality of sessions are almost simultaneously full, and aggregation information can be read only at this time. Reading cannot be performed before the aggregation information is obtained, leading to cache occupation. The occupied cache is greater than or equal to the number of sessions multiplied by a data length of one piece of aggregation information. After the data packet transmission manner provided in some embodiments is adopted, the target information is preferentially written into a session until the session is full, and then written into a next session. The session may be full more quickly, and then aggregation information may be aggregated and read, thereby reducing the cache occupation.

The data processing method is described in detail through the above embodiments. In the above embodiments, the manner of acquiring the to-be-detected network traffic, for example, the foregoing implementation of operation 301, is not limited. For ease of understanding, in some embodiments, an example in which the to-be-detected network traffic is obtained through replication is used, and the following manner is provided as an example.

In application, the switch may determine incoming transmission network traffic. The transmission network traffic may refer to network traffic that is to be forwarded by the switch. The determining may be determining whether the transmission network traffic is obtained through replication. If the transmission network traffic is obtained through replication, the transmission network traffic is network traffic configured for detection, and the transmission network traffic may be determined as to-be-detected network traffic for subsequent processing and then forwarded to the traffic detection device to implement detection. If the transmission network traffic is not obtained through replication, the transmission network traffic is network traffic configured for network communication, and the transmission network traffic may not be determined as the to-be-detected network traffic, thereby ensuring network communication. In some embodiments, during the implementation of operation 301, the switch may first acquire the transmission network traffic, and then determine the transmission network traffic. When it is determined that the transmission network traffic is obtained through replication, the transmission network traffic is determined as the to-be-detected network traffic. Correspondingly, when it is determined that the transmission network traffic is not obtained through replication, the transmission network traffic may not be determined as the to-be-detected network traffic, thereby ensuring network communication.

The manner of determining the transmission network traffic by the switch is not limited. In actual application, the network traffic may carry a type identifier, and the type identifier may be configured for characterizing whether the network traffic is obtained through replication. In some embodiments, the switch may determine the transmission network traffic using the type identifier. In some embodiments, the type identifier may include a replication identifier and a business identifier. The replication identifier may be configured for characterizing that the network traffic is obtained through replication and is network traffic configured for detection. The business identifier may be configured for characterizing that the network traffic is not obtained through replication and is network traffic configured for network communication. Corresponding to this manner, during the implementation of operation 301, the switch may first acquire the transmission network traffic. The transmission network traffic may refer to network traffic that is to be forwarded by the switch. The switch may parse the transmission network traffic to obtain a type identifier of the transmission network traffic. The type identifier of the transmission network traffic may be configured for characterizing whether the transmission network traffic is obtained through replication. If the type identifier is a replication identifier, the transmission network traffic is obtained through replication. The switch may determine the transmission network traffic as the to-be-detected network traffic. Correspondingly, if the type identifier is a business identifier, the transmission network traffic is not obtained through replication, but is network traffic configured for network communication. The transmission network traffic may not be determined as the to-be-detected network traffic. The transmission network traffic may be determined through the type identifier.

The manner of acquiring the transmission network traffic is not limited. The transmission network traffic may refer to network traffic that is to be forwarded by the switch. In actual application, the network traffic configured for network communication is forwarded by the switch, and the network traffic configured for detection is further forwarded by the switch. It can be learned that the transmission network traffic may include both the network traffic configured for detection and the network traffic configured for network communication. The network traffic configured for detection is obtained by replicating the network traffic configured for network communication. Different replication manners may lead to different manners of acquiring the transmission network traffic. For ease of understanding, in some embodiments, the following two manners are provided as examples.

In actual application, the switch may first acquire initial network traffic. The initial network traffic may refer to the network traffic configured for network communication. Correspondingly, a type identifier of the initial network traffic is a business identifier. In some embodiments, after acquiring the initial network traffic, the switch may directly perform multicast replication on the initial network traffic to obtain replicated network traffic. A type identifier of the replicated network traffic is a replication identifier. The switch may determine the initial network traffic and the replicated network traffic as the transmission network traffic. Multicast replication is a flexible replication manner, and the number of replications may be flexibly controlled. The multicast replication manner facilitates improving the flexibility of implementing the method provided in some embodiments. First replicating the initial network traffic may be considered as a pre-replication manner so that the transmission network traffic not only includes the initial network traffic but also includes the replicated network traffic. According to the pre-replication manner, detection may be performed after the transmission network traffic is received, thereby facilitating improving the detection efficiency.

Different from the foregoing pre-replication manner, in some embodiments, a post-replication manner may further be adopted. For example, the switch temporarily does not replicate the acquired initial network traffic, but determines the acquired initial network traffic and then replicates it for subsequent detection. In some embodiments, the switch may first acquire the initial network traffic and determine the acquired initial network traffic as the transmission network traffic. The type identifier of the initial network traffic is the business identifier. The transmission network traffic received by the switch may be the initial network traffic first. After determining that the type identifier of the transmission network traffic is the business identifier, to implement detection without affecting network communication, the switch may replicate the transmission network traffic and determine the replicated network traffic obtained through replication as the transmission network traffic. The type identifier of the replicated network traffic is the replication identifier. Correspondingly, the transmission network traffic subsequently received by the switch may be the replicated network traffic and may be configured for subsequent detection. According to the post-replication manner, the transmission network traffic may be the initial network traffic first and may be the replicated network traffic subsequently so that network communication may be ensured, and detection may be implemented. According to the post-replication manner, replication may be performed after determining, which is more flexible.

The manner of acquiring the initial network traffic is not limited. In actual application, the initial network traffic may refer to the network traffic configured for network communication, and may refer to network traffic transmitted between devices. The foregoing example in which the first device transmits the network traffic to the second device is used. In the process of transmitting the network traffic by the first device to the second device, the switch may acquire the initial network traffic from the transmitted network traffic. In actual application, the first device may transmit the network traffic to the second device using a device interface as a basic unit. Correspondingly, the switch may acquire the initial network traffic from the device interface of the first device. Detection may further be considered as network traffic detection using the device interface as the basic unit, thereby facilitating locating an abnormal device interface and the like. The network traffic transmitted by the first device to the second device may be further classified according to detection requirements. Whether the transmitted network traffic is to be detected is distinguished based on the classification, and network traffic that is to be detected is screened and determined as the initial network traffic for subsequent detection. Network traffic that may not be detected is directly forwarded to the second device.

In the network traffic detection, the network traffic detection may be evaluated from two dimensions: detection accuracy and a bandwidth cost. A higher ratio of detecting the transmitted network traffic is more beneficial to ensure the detection accuracy, and a lower ratio of detecting the transmitted network traffic is more beneficial to reduce the bandwidth cost. Different ratios of detecting the transmitted network traffic refer to different ratios of acquiring the initial network traffic from the transmitted network traffic. Different network traffic detection scenes may correspond to different detection requirements. For example, some network traffic detection scenes focus more on the detection accuracy, while some network traffic detection scenes focus more on the bandwidth cost. The ratio of acquiring the initial network traffic may be adjusted so that detection can be flexibly applied to various network traffic detection scenes.

In actual application, the ratio of acquiring the initial network traffic may be adjusted by setting a sampling ratio. In some embodiments, in the process of transmitting the network traffic by the first device to the second device, the switch may sample the transmitted network traffic according to the sampling ratio to obtain the initial network traffic. The sampling ratio may refer to the ratio of acquiring the initial network traffic from the transmitted network traffic, and may refer to a ratio of the quantity of the transmitted network traffic to the quantity of the initial network traffic. In actual application, the transmitted network traffic may be sampled according to the sampling ratio using the sFlow network traffic detection technology supported by an Internet standard request for comments (RFC). A detection ratio may be adjusted by setting the sampling ratio so that detection better satisfies an actual detection requirement.

Setting of the sampling ratio is not limited. For ease of understanding, in some embodiments, the following manner is provided as an example.

To ensure the detection accuracy, in some embodiments, the sampling ratio may be set to 1:1, for example, the ratio of the quantity of the transmitted network traffic to the quantity of the initial network traffic is 1:1. All transmitted network traffic may be detected. Comprehensive detection is realized. The network traffic may be precisely detected and analyzed so that omission of stateful network traffic (for example, abnormal network traffic) is effectively reduced, thereby ensuring the detection accuracy. For a sampling manner with a sampling ratio of 1:1, if another manner in which the full volume of the network traffic is transmitted to the traffic detection device is used, although the detection accuracy can be ensured, the bandwidth cost is relatively high. Compared with the related art, after the method provided in some embodiments is adopted, only the target information (for example, effective information) is to be transmitted to the traffic detection device. The bandwidth cost can be reduced while ensuring the detection accuracy. For a network traffic detection scene in which the volume of network traffic may be large, after this application is adopted, the bandwidth cost of network traffic detection can be greatly reduced based on ensuring the detection accuracy. In actual application, in the same network traffic detection scene, for a case in which the initial network traffic is the same and the quantity of the initial network traffic is also the same, the bandwidth cost used by adopting this application is approximately 8% of the original one, which is reduced by approximately 92%, thereby greatly reducing the bandwidth cost of network traffic detection.

In actual application, due to the consideration of the bandwidth cost, the sampling ratio may further be set as N:1, N being an integer greater than 1, for example, the ratio of the quantity of the transmitted network traffic to the quantity of the initial network traffic is N:1. In some embodiments, one piece of initial network traffic may be sampled each time N pieces of network traffic are transmitted. The ratio of detection may be effectively reduced, thereby facilitating reducing the bandwidth cost. For a sampling manner with a sampling ratio of N:1, if another manner in which the full volume of the network traffic is transmitted to the traffic detection device is used, the bandwidth cost can be reduced to some extent by reducing the quantity. Compared with the related art, after the method provided in some embodiments is adopted, only the target information (for example, effective information) is to be transmitted to the traffic detection device. The bandwidth cost can be further reduced. For example, in a case that N is the same, the bandwidth cost used by adopting this application is lower. In a case that the consumed bandwidth costs are the same, N may be set to a smaller value by adopting this application to increase a ratio of detected network traffic, thereby improving the detection accuracy.

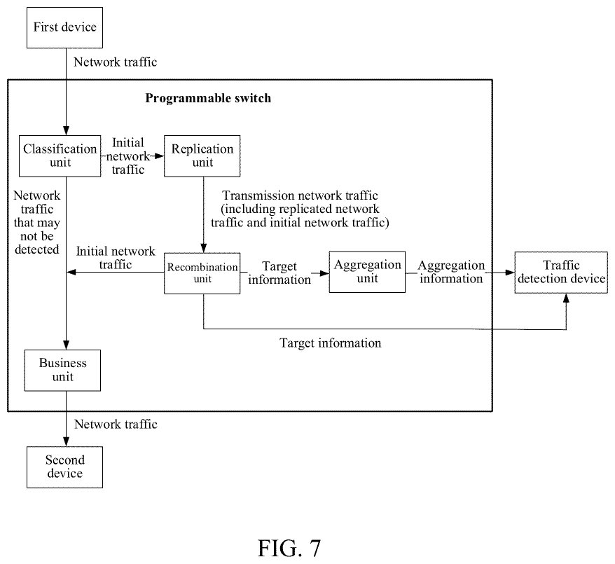

To facilitate understanding of the method embodiments, a scene in which the first device transmits network traffic to the second device is described below using an example in which the switch is the foregoing programmable switch. Correspondingly, FIG. 7 is a schematic diagram of a system architecture of network traffic detection. A first device, a second device, a programmable switch, and a traffic detection device may be included. The data processing method provided in some embodiments may be performed by the programmable switch. The programmable switch may include a classification unit, a replication unit, a recombination unit, an aggregation unit, and a business unit.

The classification unit may be configured to classify network traffic transmitted by the first device to the second device, screen network traffic that may be detected, and sample the network traffic according to a sampling ratio to obtain initial network traffic. In actual application, execution logic of the classification unit may be referred to as inbound processing logic, and the inbound processing logic may be written based on the programmability of the programmable switch.

The replication unit may be configured to replicate the initial network traffic. Timing at which the replication unit replicates the initial network traffic is different so that the transmission network traffic output by the replication unit is different. In actual application, a packet replication engine (PRE) of the programmable switch may be adopted to replicate the network traffic that is to be replicated.

The recombination unit may be configured to parse the transmission network traffic, determine a type identifier, distinguish replicated network traffic and determine it as to-be-detected network traffic, and perform information extraction on the to-be-detected network traffic to obtain target information. Correspondingly, the distinguished initial network traffic may be transmitted to the business unit. In actual application, outbound processing logic may be configured in the recombination unit so that the replicated network traffic is distinguished from the initial network traffic based on the outbound processing logic, and the distinguished replicated network traffic may be modified to reserve effective information, for example, the target information. Using an example in which the network traffic is a message, extracted message fields carrying the effective information may further be recombined to obtain target information that is also in a message form.

Execution statements of the outbound processing logic in the recombination unit may be as follows:

```
If packet is mirrored:
  modification is performed, and effective information is reserved;
Else:
  modification is not performed.
```

The packet may refer to the transmission network traffic.

After the recombination unit obtains the target information, if the target information corresponds to the foregoing normal mirror, the recombination unit may transmit the obtained target information to the traffic detection device. The target information may be transmitted to the traffic detection device through a port of the programmable switch. Corresponding to the foregoing collescing mirror, the recombination unit may transmit the obtained target information to the aggregation unit. In actual application, the process of obtaining the target information based on information extraction may further be considered as a process of replicating the target information from the to-be-detected network traffic. The to-be-detected network traffic may be modified and effective information is reserved. Content of the modified to-be-detected network traffic is replicated using the underlying capability of the collescing mirror of a programmable switching chip of the programmable switch, to obtain the target information. The modified to-be-detected network traffic may be discarded. In actual application, the recombination unit may include mirror logic. A used mode may be determined based on the mirror logic. Corresponding to different modes, the target information is transmitted in different transmission procedures, and the distinguished initial network traffic may be transmitted to the business unit. Execution statements of the mirror logic may be as follows.

```
If mode is collescing mirror:
  the target information is written into the cache address;
If mode is normal mirror:
  the target information is transmitted to the business unit;
Else:
  the initial network traffic is transmitted to the business unit.
```

The mode may refer to a currently used processing mode, and may be the foregoing collescing mirror, for example, mode is collescing mirror, or may be the foregoing normal mirror, for example, mode is normal mirror. Other cases may refer to that for the initial network traffic that is not modified, the initial network traffic may be transmitted to the business unit.

The aggregation unit may be configured to aggregate the received target information, and after aggregating a plurality of pieces of target information to one piece of aggregation information, transmit the aggregation information to the traffic detection device. The aggregation information may be transmitted to the traffic detection device through the port of the programmable switch. The aggregation unit may include two parts: packet transmission and caching. The packet transmission part may be configured to control a transmission manner of transmitting the plurality of pieces of target information to corresponding cache addresses. The packet transmission part may be performed using the foregoing structure of the binary tree, and may be implemented based on a multi-level register of the programmable switch, which can reduce the cache occupation and improve the cache utilization. The caching part may refer to writing the target information into a corresponding cache address, and after the cache address is full, reading aggregation information of a predetermined length from the cache address and transmitting the aggregation information. Corresponding to that the recombination unit obtains the target information through replication using the underlying capability of the collescing mirror of the programmable switching chip, the aggregation unit may write the target information into a cache address corresponding to the collescing mirror of the programmable switching chip, for example, on-chip storage of the programmable switching chip, and a static random-access memory (SRAM). After the target information is aggregated to a predetermined length, the stored SARM information may be read. Aggregation information of a predetermined length may be read, and this cache space is released.

The business unit is configured to transmit the network traffic that is output by the classification unit and that may not be detected and the initial network traffic output by the recombination unit to the second device. The business unit may transmit the network traffic to the second device through the port of the programmable switch to implement forwarding and ensure network communication.

Corresponding to the foregoing two different manners, for example, the post-replication manner and the pre-replication manner, some embodiments provide schematic diagrams of processing logic corresponding to the two manners. The descriptions may include.

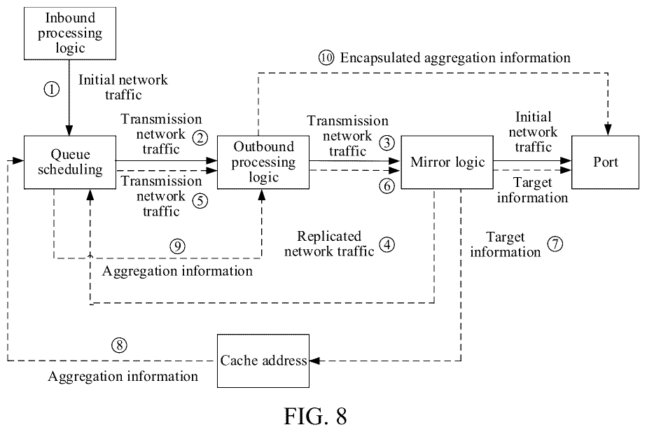

The post-replication manner is described with reference to FIG. 8. FIG. 8 is a schematic diagram of processing logic of double mirroring. In FIG. 8, initial network traffic obtained after inbound processing logic processing enters queue scheduling (as shown in (1) in the figure). The queue scheduling may be configured for scheduling the network traffic, and a port to be used for transmitting the network traffic may be determined based on the queue scheduling. In actual application, scheduling processing may be a traffic manager. Based on the queue scheduling, transmission network traffic may be scheduled to enter outbound processing logic (as shown in (2) in the figure). Based on the outbound processing logic, it is determined that a type identifier of the transmission network traffic is a business identifier, and therefore modification is not performed. To perform detection, the transmission network traffic may enter mirror logic (as shown in (3) in the figure). The transmission network traffic is replicated based on the mirror logic, and replicated network traffic obtained through replication is determined as the transmission network traffic to enter a scheduling unit (as shown in (4) in the figure). The queue scheduling schedules the current transmission network traffic into the outbound processing logic (as shown in (5) in the figure). It may be determined, through determining of the outbound processing logic, that the transmission network traffic is obtained through replication. Modification may be performed, and effective information, for example, target information, is reserved based on the modification. The transmission network traffic enters the mirror logic (as shown in (6) in the figure). If it is determined that the collescing mirror is adopted, the content reserved after the modification may be replicated using the underlying capability of the collescing mirror and then transmitted to an aggregation unit. The aggregation unit may write the target information into a cache address (as shown in (7) in the figure), and when the cache address is full or the target information is aggregated to a predetermined length, may read aggregation information of the predetermined length from the cache address (as shown in (8) in the figure). Outer encapsulation may further be performed on the read aggregation information, by encapsulating an address of the traffic detection device with the aggregation information. Since the aggregation information may be transmitted to the traffic detection device, the read aggregation information may enter the queue scheduling, and a port corresponding to a switch is determined to be subsequently used through the queue scheduling, to facilitate transmission to the traffic detection device. In actual application, outer encapsulation may be implemented by programming the outbound processing logic. Correspondingly, the aggregation information after the queue scheduling may enter the outbound processing logic (as shown in (9) in the figure), the outer encapsulation is completed based on processing of the outbound processing logic, and encapsulated aggregation information may enter the port (as shown in (10) in the figure). Finally, the aggregation information may be transmitted to a corresponding traffic detection device using the port. If it is determined that the normal mirror is adopted, the target information is pushed to the port of the programmable switch. The transmission network traffic whose type identifier is the business identifier, for example, the initial network traffic, is determined based on the mirror logic and then pushed to the port. In this post-replication manner, after determining of the outbound processing logic, two replications are performed. The first replication is shown in (4) in the figure, and the second replication is shown in (7) in the figure. The two replications may be referred to as double mirroring, and therefore may further be referred to as a double mirroring manner.

In FIG. 8, for ease of distinguishing, a procedure of related information obtained through replication (for example, replicated network traffic obtained through replication, or target information obtained through replication) is indicated using a dashed arrow, and a procedure of initial network traffic is indicated using a solid arrow.

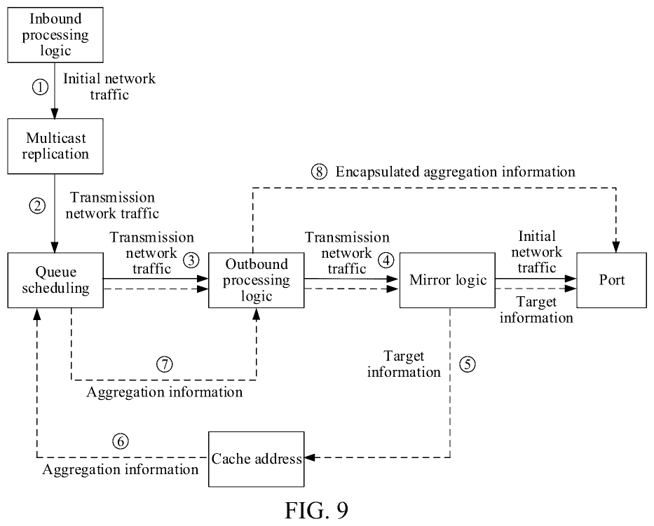

The pre-replication manner is described with reference to FIG. 9. FIG. 9 is a schematic diagram of processing logic of multicast replication combined with single mirroring. In FIG. 9, initial network traffic obtained after inbound processing logic processing enters multicast replication (as shown in (1) in the figure). For example, multicast replication is directly performed on the initial network traffic through a replication unit to obtain corresponding replicated network traffic. The multicast replication may be completed using the replication unit based on a PRE. The initial network traffic and the replicated network traffic may be determined as transmission network traffic to enter queue scheduling (as shown in (2) in the figure). Since the transmission network traffic includes both the initial network traffic and the replicated network traffic, in queue scheduling, outbound processing logic, and subsequent processing, for ease of distinguishing, the processing is similar to that of FIG. 8. FIG. 9 shows solid arrows and dashed arrows. A procedure of the initial network traffic is indicated using the solid arrow, and a procedure of related information obtained through replication is indicated using the dashed arrow. The transmission network traffic enters the outbound processing logic (as shown in (3) in the figure) and then is determined based on the outbound processing logic. If it is determined that a type identifier is a business identifier, modification is not performed. If it is determined that the type identifier is a replication identifier, modification is performed, and effective information, for example, the target information, is reserved based on the modification. The non-modified network traffic and the modified network traffic in the transmission network traffic enter mirror logic (as shown in (4) in the figure). If it is determined that the collescing mirror is adopted, content reserved after the modification may be replicated using the underlying capability of the collescing mirror and then transmitted to an aggregation unit. The aggregation unit may write the target information into a cache address (as shown in (5) in the figure), and when the cache address is full or the target information is aggregated to a predetermined length, may read aggregation information of the predetermined length from the cache address (as shown in (6) in the figure). Outer encapsulation may further be performed on the read aggregation information, by encapsulating an address of the traffic detection device with the aggregation information. Since the aggregation information may be transmitted to the traffic detection device, the read aggregation information may enter the queue scheduling, and a port corresponding to a switch is determined to be subsequently used through the queue scheduling, to facilitate transmission to the traffic detection device. In actual application, outer encapsulation may be implemented by programming the outbound processing logic. Correspondingly, the aggregation information after the queue scheduling may enter the outbound processing logic (as shown in (7) in the figure), the outer encapsulation is completed based on processing of the outbound processing logic, and encapsulated aggregation information may enter the port (as shown in (8) in the figure). Finally, the aggregation information may be transmitted to a corresponding traffic detection device using the port. If it is determined that the normal mirror is adopted, the target information is pushed to the port of the programmable switch. The transmission network traffic whose type identifier is the business identifier, for example, the initial network traffic, is determined based on the mirror logic and then pushed to the port. In this pre-replication manner, the multicast replication is performed before the outbound processing logic (as shown in (2) in the figure), and only one replication may be performed after the outbound processing logic (as shown in (5) in the figure). This manner may be referred to as a manner of multicast replication combined with single mirroring.

As can be seen from the foregoing technical solutions, when the network traffic is to be detected in network communication, the to-be-detected network traffic may be first acquired. The to-be-detected network traffic may refer to network traffic configured for detection. Information extraction may be performed on the to-be-detected network traffic to obtain the target information corresponding to the to-be-detected network traffic. The target information may refer to information for detecting the to-be-detected network traffic, for example, the target information is effective information for detection. After the target information is obtained, the target information may be transmitted to the traffic detection device. The traffic detection device may detect the target information to obtain the detection result corresponding to the to-be-detected network traffic, thereby realizing detection. Since the data volume of the target information is less than the data volume of the to-be-detected network traffic, a bandwidth cost for transmitting the target information to the traffic detection device is less than a bandwidth cost for transmitting the to-be-detected network traffic so that the bandwidth cost can be reduced based on detecting the network traffic.

In an actual network traffic detection scene, when forwarding received network traffic to the traffic detection device, the switch may first encapsulate the network traffic. The encapsulation may be encapsulating other related information with the network traffic, for example, encapsulating an IP address of a network traffic receiving end (for example, an IP address of the traffic detection device) with the network traffic. Transmission may be performed based on the IP address carried after the encapsulation. In alternative implementations, each piece of network traffic is encapsulated. In a network traffic detection scene with a very large volume of network traffic, the quantity of network traffic that is to be detected is large. Each piece of network traffic that is to be detected is encapsulated and then transmitted in an encapsulation manner. Each piece of network traffic that is to be detected may be transmitted once, and each piece of transmitted network traffic carries an encapsulated IP address and the like. Many transmission resources are occupied, and the bandwidth cost is relatively high.

Some embodiments further provide a data processing manner, which may be applied to a switch. The switch may aggregate a plurality of pieces of network traffic that is to be detected, and encapsulate the plurality of pieces of network traffic into one piece of detection traffic based on the aggregation. The detection traffic obtained through encapsulation may include the plurality of pieces of network traffic. The switch may transmit the detection traffic to the traffic detection device to perform detection. Since the plurality of pieces of network traffic may be encapsulated in one piece of detection traffic, encapsulation may be performed only once. Correspondingly, only one IP address may be encapsulated in the plurality of pieces of network traffic, and the one piece of detection traffic contains a plurality of pieces of network traffic. Transmitting the one piece of detection traffic may realize transmitting the plurality of pieces of network traffic so that the bandwidth cost can be reduced.

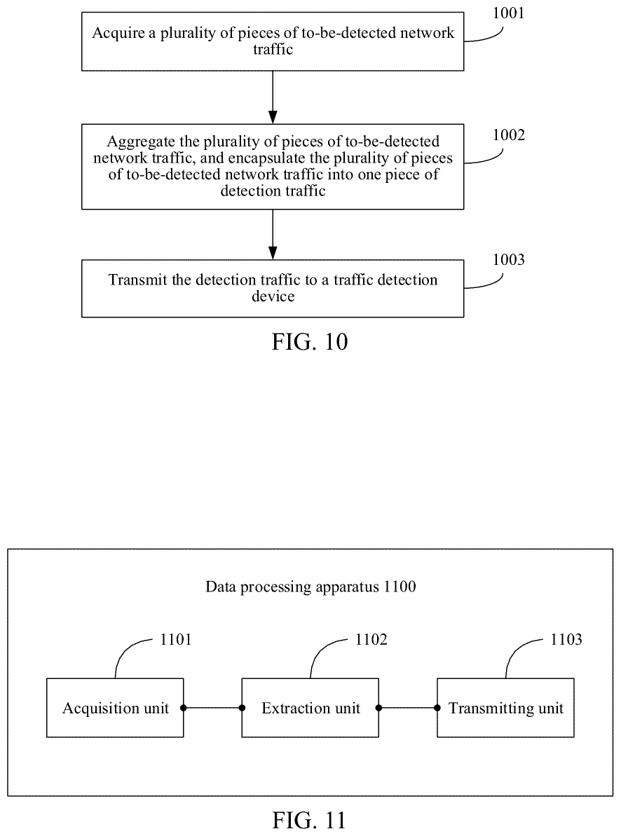

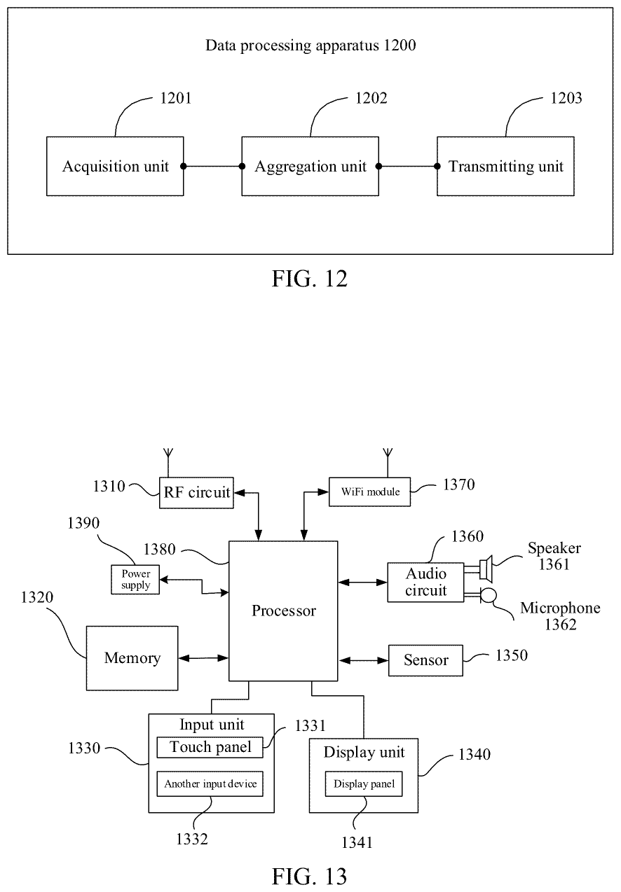

Correspondingly, FIG. 10 is a flowchart of a data processing method according to some embodiments. An example in which a switch is used as the foregoing computer device is used for description. The method includes operations 1001 to 1003.

Operation 1001: Acquire a plurality of pieces of to-be-detected network traffic.

When network traffic is to be detected, the switch may acquire a plurality of pieces of to-be-detected network traffic. The to-be-detected network traffic may refer to network traffic configured for detection. In actual application, the switch may acquire the to-be-detected network traffic from a port of a transmitting device of the network traffic (for example, the foregoing first device). A manner of acquiring the plurality of pieces of to-be-detected network traffic may refer to some embodiments of operation 301.

Operation 1002: Aggregate the plurality of pieces of to-be-detected network traffic, and encapsulate the plurality of pieces of to-be-detected network traffic into one piece of detection traffic.

For the plurality of pieces of acquired to-be-detected network traffic, the switch may aggregate the plurality of pieces of to-be-detected network traffic and encapsulate the plurality of pieces of to-be-detected network traffic into one piece of detection traffic. The detection traffic may contain a plurality of pieces of to-be-detected network traffic, and there is only one piece of detection traffic. For example, the plurality of pieces of to-be-detected network traffic may be encapsulated only once, thereby facilitating reducing the bandwidth cost.

The manner of performing aggregation and encapsulation into one piece of detection traffic is not limited. In actual application, different aggregation and encapsulation manners may result in different pieces of detection traffic, and the different pieces of detection traffic may refer to different contents of the detection traffic. The content of the detection traffic is directly related to the detection result, and detection traffic with different contents may obtain different detection results. For ease of understanding, in some embodiments, the following manner is provided as an example.

In actual application, the switch, as a forwarding device of the network traffic, is an intermediate device compared with the transmitting device and receiving device of the network traffic. In a network traffic detection scene, a switch used as an intermediate device may be responsible for forwarding and detecting network traffic from a plurality of transmitting devices. For example, the foregoing plurality of pieces of to-be-detected network traffic may be to-be-detected network traffic from a plurality of sources. One of main objectives of detection is to locate a source of an abnormality. To ensure that the source of the abnormality can be located based on a detection result, sources of the to-be-detected network traffic may be aggregated and encapsulated in the detection traffic. The source of the to-be-detected network traffic may be configured for indicating a port of a device, a device, or the like from which the to-be-detected network traffic comes. In actual application, for the plurality of pieces of to-be-detected network traffic, the plurality of pieces of to-be-detected network traffic may be processed first to determine the sources of the to-be-detected network traffic. One piece of detection traffic may be obtained based on aggregation and encapsulation, and the sources of the to-be-detected network traffic are encapsulated in one piece of detection traffic based on aggregation and encapsulation. The obtained piece of detection traffic may reflect the sources of the to-be-detected network traffic. After the detection traffic is detected, once it is detected that an abnormality exists, a port, a device, and the like that are abnormal can be located based on the source.

The quantity of the to-be-detected network traffic from the same source may further be aggregated. Correspondingly, the quantity of the to-be-detected network traffic from various sources may be encapsulated in the detection traffic, and the detection traffic obtained based on this may further reflect the quantity of the to-be-detected network traffic from the same source. After the detection traffic is detected, network security statuses of a plurality of sources may further be evaluated using an abnormality proportion of the to-be-detected network traffic from the same source. For example, a higher abnormality proportion of a source indicates a less secure network of the source.

Operation 1003: Transmit the detection traffic to a traffic detection device.

The traffic detection device may be configured to detect the detection traffic to obtain detection results corresponding to the plurality of pieces of to-be-detected network traffic. Detection is completed. Since the plurality of pieces of network traffic may be encapsulated in one piece of detection traffic, encapsulation may be performed only once. Correspondingly, only one IP address may be encapsulated in the plurality of pieces of network traffic, and the one piece of detection traffic contains a plurality of pieces of network traffic. Transmitting the one piece of detection traffic may realize transmitting the plurality of pieces of network traffic so that the bandwidth cost for detection can be reduced based on realizing detection.

For better understanding, an example in which the switch is the foregoing programmable switch is used. To facilitate aggregation and encapsulation of the plurality of pieces of to-be-detected network traffic into one piece of detection traffic, the plurality of pieces of to-be-detected network traffic may be written into cache addresses corresponding to the programmable switching chip using the underlying capability of the collescing mirror of a programmable switching chip of the programmable switch. The plurality of pieces of to-be-detected network traffic may be cached and stored using the cache addresses. After the cache address is full, aggregation and encapsulation may be performed to obtain one piece of corresponding detection traffic, thereby facilitating saving the hardware performance of the switch. For example, the performance of the programmable switching chip of the programmable switch may be saved.

As can be seen from the foregoing technical solutions, when network traffic is to be detected in network communication, a plurality of pieces of to-be-detected network traffic may be aggregated and encapsulated into one piece of detection traffic. The one piece of detection traffic may contain the plurality of pieces of to-be-detected network traffic. The detection of the plurality of pieces of to-be-detected network traffic can be ensured based on the manner of detecting the one piece of detection traffic. Since the plurality of pieces of to-be-detected network traffic are encapsulated into one piece of detection traffic, encapsulation may be performed only once. In actual application, an example in which an IP address is encapsulated is used. After this application is adopted, only one IP address may be encapsulated in a plurality of pieces of to-be-detected network traffic. Transmitting the one piece of detection traffic may realize transmitting the plurality of pieces of network traffic so that the bandwidth cost for detection can be reduced based on realizing detection.

In some embodiments, based on some embodiments provided in the foregoing aspects, further combinations may be performed to provide more implementations.

Based on the data processing method provided in some embodiments corresponding to FIG. 3, some embodiments further provide a data processing apparatus 1100. The data processing apparatus 1100 includes an acquisition unit 1101, an extraction unit 1102, and a transmitting unit 1103.

The acquisition unit 1101 is configured to acquire to-be-detected network traffic.

The extraction unit 1102 is configured to perform information extraction on the to-be-detected network traffic to obtain target information corresponding to the to-be-detected network traffic, a data volume of the target information being less than a data volume of the to-be-detected network traffic.

The transmitting unit 1103 is configured to transmit the target information to a traffic detection device, the traffic detection device being configured to detect the target information to obtain a detection result corresponding to the to-be-detected network traffic.

In some embodiments, the to-be-detected network traffic includes n pieces of to-be-detected network traffic, n being an integer greater than 1, and the transmitting unit is further configured to:
aggregate target information corresponding to the n pieces of to-be-detected network traffic; and
transmit aggregation information obtained through aggregation to the traffic detection device, the traffic detection device being configured to detect received aggregation information to obtain a detection result.

In some embodiments, the apparatus further includes a writing unit.

The writing unit is configured to write the target information corresponding to the n pieces of to-be-detected network traffic into cache addresses.

The transmitting unit is further configured to:
aggregate the target information corresponding to the n pieces of to-be-detected network traffic written into the cache addresses; and
read the aggregation information obtained through aggregation from the cache addresses, and transmit read aggregation information to the traffic detection device.

In some embodiments, the cache addresses include a first cache address and a second cache address, the data volume of the target information is a preset data length, and the writing unit is further configured to:
write, for an i-th piece of target information corresponding to an i-th piece of to-be-detected network traffic in the n pieces of to-be-detected network traffic, the i-th piece of target information into the first cache address if it is determined that a remaining cache length of the first cache address is greater than or equal to the preset data length, i being an integer greater than or equal to 2 and less than or equal to n, and the first cache address storing an (i−1)-th piece of target information corresponding to an (i−1)-th piece of to-be-detected network traffic in the n pieces of to-be-detected network traffic;
write the i-th piece of target information into the second cache address if it is determined that the remaining cache length of the first cache address is less than the preset data length; and
completely write n pieces of target information corresponding to the n pieces of to-be-detected network traffic into the cache addresses.

In some embodiments, a maximum cache length of the first cache address includes m preset data lengths, m being an integer greater than 1, and the writing unit is further configured to:
determine that the remaining cache length of the first cache address is greater than or equal to the preset data length if i≤m; and
determine that the remaining cache length of the first cache address is less than the preset data length if i>m.

In some embodiments, the first cache address corresponds to a first child node, the second cache address corresponds to a second child node, and the first child node and the second child node correspond to the same parent node; the parent node is a node that receives the i-th piece of target information among nodes included in a binary tree, and the writing unit is further configured to:
determine that the remaining cache length of the first cache address is greater than or equal to the preset data length if a length of historical information transmitted by the parent node through the first child node is less than a maximum cache length of the first child node, the maximum cache length of the first child node being determined according to the number of layers of the parent node in the binary tree and a maximum cache length of the first cache address, and the maximum cache length of the first cache address including m preset data lengths, m being an integer greater than 1;
transmit the i-th piece of target information to the first child node using the parent node, and write the i-th piece of target information into the first cache address through the first child node;
determine that the remaining cache length of the first cache address is less than the preset data length if the length of the historical information transmitted by the parent node through the first child node is equal to the maximum cache length of the first child node; and
transmit the i-th piece of target information to the second child node using the parent node, and write the i-th piece of target information into the second cache address through the second child node.

In some embodiments, the transmitting unit is further configured to:
determine, in a process of writing the n pieces of to-be-detected network traffic into the cache addresses, a cache address that stores m pieces of target information among the first cache address and the second cache address as a target cache address;
perform aggregation based on the m pieces of target information stored in the target cache address; and
completely aggregate the target information corresponding to the n pieces of to-be-detected network traffic.

In some embodiments, the acquisition unit is further configured to:
acquire transmission network traffic;
parse the transmission network traffic to obtain a type identifier of the transmission network traffic; and
determine, if the type identifier is a replication identifier, the transmission network traffic as the to-be-detected network traffic.

In some embodiments, the acquisition unit is further configured to:
acquire initial network traffic, a type identifier of the initial network traffic being a business identifier;
perform multicast replication on the initial network traffic to obtain replicated network traffic, a type identifier of the replicated network traffic being the replication identifier; and
determine the initial network traffic and the replicated network traffic as the transmission network traffic.

In some embodiments, the acquisition unit is further configured to:
acquire initial network traffic, and determine acquired initial network traffic as the transmission network traffic, a type identifier of the initial network traffic being a business identifier; and
replicate, after it is determined that the type identifier of the transmission network traffic is the business identifier, the transmission network traffic, and determine replicated network traffic obtained through replicating as the transmission network traffic, a type identifier of the replicated network traffic being the replication identifier.

In some embodiments, the acquisition unit is further configured to:

sample, in a process of transmitting network traffic by a first device to a second device, transmitted network traffic according to a sampling ratio to obtain the initial network traffic.

As can be seen from the foregoing technical solutions, when the network traffic is to be detected in network communication, the to-be-detected network traffic may be first acquired. The to-be-detected network traffic may refer to network traffic configured for detection. Information extraction may be performed on the to-be-detected network traffic to obtain the target information corresponding to the to-be-detected network traffic. The target information may refer to information for detecting the to-be-detected network traffic, for example, the target information is effective information for detection. After the target information is obtained, the target information may be transmitted to the traffic detection device. The traffic detection device may detect the target information to obtain the detection result corresponding to the to-be-detected network traffic, thereby realizing detection. Since the data volume of the target information is less than the data volume of the to-be-detected network traffic, a bandwidth cost for transmitting the target information to the traffic detection device is less than a bandwidth cost for transmitting the to-be-detected network traffic so that the bandwidth cost can be reduced based on detecting the network traffic.

Based on the data processing method provided in some embodiments corresponding to FIG. 10, some embodiments further provide another data processing apparatus 1200. The data processing apparatus 1200 includes an acquisition unit 1201, an aggregation unit 1202, and a transmitting unit 1203.

The acquisition unit 1201 is configured to acquire a plurality of pieces of to-be-detected network traffic.

The aggregation unit 1202 is configured to aggregate the plurality of pieces of to-be-detected network traffic, and encapsulate the plurality of pieces of to-be-detected network traffic into one piece of detection traffic.

The transmitting unit 1203 is configured to transmit the detection traffic to a traffic detection device, the traffic detection device being configured to detect the detection traffic to obtain detection results corresponding to the plurality of pieces of to-be-detected network traffic.

As can be seen from the foregoing technical solutions, when network traffic is to be detected in network communication, a plurality of pieces of to-be-detected network traffic may be aggregated and encapsulated into one piece of detection traffic. The one piece of detection traffic may contain the plurality of pieces of to-be-detected network traffic. The detection of the plurality of pieces of to-be-detected network traffic can be ensured based on the manner of detecting the one piece of detection traffic. Since the plurality of pieces of to-be-detected network traffic are encapsulated into one piece of detection traffic, encapsulation may be performed only once. In actual application, an example in which an IP address is encapsulated is used. After this application is adopted, only one IP address may be encapsulated in a plurality of pieces of to-be-detected network traffic. Transmitting the one piece of detection traffic may realize transmitting the plurality of pieces of network traffic so that the bandwidth cost for detection can be reduced based on realizing detection.

Some embodiments further provide a computer device. The computer device may be a terminal. Using the terminal as a smartphone as an example,

FIG. 13 is a block diagram of a partial structure of a smartphone according to some embodiments. Referring to FIG. 13, the smartphone includes: a radio frequency (RF) circuit 1310, a memory 1320, an input unit 1330, a display unit 1340, a sensor 1350, an audio circuit 1360, a wireless fidelity (WiFi) module 1370, a processor 1380, a power supply 1390, and other components. The input unit 1330 may include a touch panel 1331 and another input device 1332. The display unit 1340 may include a display panel 1341. The audio circuit 1360 may include a speaker 1361 and a microphone 1362. A person skilled in the art may understand that the structure of the smartphone shown in FIG. 13 does not constitute a limitation on the smartphone, and the smartphone may include more components or fewer components than those shown in the figure, or some components may be combined, or a different component arrangement may be used.

The memory 1320 may be configured to store software programs and modules, and the processor 1380 executes various functional applications and data processing of the smartphone by running the software programs and the modules stored in the memory 1320. The memory 1320 may include a program storage area and a data storage area. The program storage area may store an operating system, an application program used by at least one function (such as a sound playing function and an image playing function), for example The data storage area may store data (such as audio data and a phone book) created according to the use of the mobile phone, for example The memory 1320 may include a high-speed random access memory (RAM) and a non-volatile memory, such as at least one magnetic disk storage device, a flash memory device, or other volatile solid-state storage devices.

The processor 1380 is a control center of the smartphone, connects various parts of the whole smartphone using various interfaces and lines, and executes various functions and processing data of the smartphone by running or executing software programs and/or modules stored in the memory 1320 and invoking data stored in the memory 1320. In some embodiments, the processor 1380 may include one or more processing units. Preferably, the processor 1380 may integrate an application processor and a modem processor. The application processor processes an operating system, a user interface, an application program, and the like. The modem processor processes wireless communication. The above-mentioned modem processor may not be integrated into the processor 1380.

In some embodiments, operations performed by the processor 1380 in the smartphone may be implemented based on the structure shown in FIG. 13.

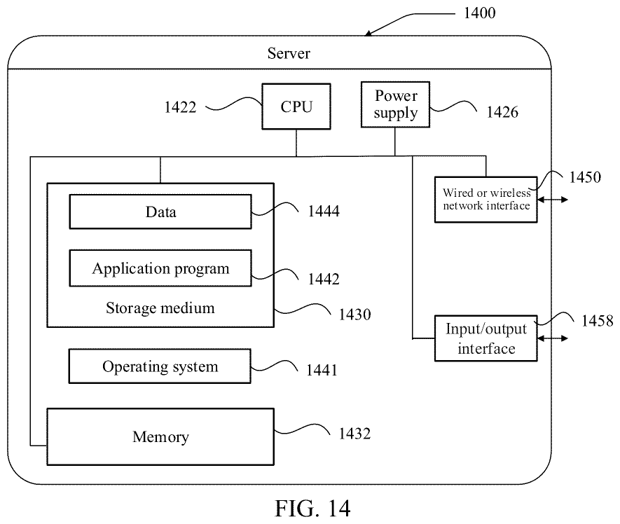

The computer device provided by some embodiments may be a server. FIG. 14 is a structural diagram of a server 1400 according to some embodiments. The server 1400 may vary greatly due to different configurations or performance, and may include one or more processors, such as central processing units (CPUs) 1422, a memory 1432, and one or more storage media 1430 (such as one or more mass storage devices) that store an application program 1442 or data 1444. The memory 1432 and the storage medium 1430 may be transient storage or persistent storage. A program stored in the storage medium 1430 may include one or more modules, and each module may include a series of instruction operations on the server. The CPU 1422 may be configured to communicate with the storage medium 1430 and perform, on the server 1400, the series of instruction operations on the storage medium 1430.

The server 1400 may further include one or more power supplies 1426, one or more wired or wireless network interfaces 1450, one or more input/output interfaces 1458, and/or one or more operating systems 1441, such as Windows Server, Mac OS X, Unix, Linux, and FreeBSD.

In the data processing method embodiment provided based on FIG. 3, the CPU 1422 in the server 1400 may perform the following operations:
acquiring to-be-detected network traffic;
performing information extraction on the to-be-detected network traffic to obtain target information corresponding to the to-be-detected network traffic, a data volume of the target information being less than a data volume of the to-be-detected network traffic; and
transmitting the target information to a traffic detection device, the traffic detection device being configured to detect the target information to obtain a detection result corresponding to the to-be-detected network traffic.

In the data processing method embodiment provided based on FIG. 10, the CPU 1422 in the server 1400 may perform the following operations:
acquiring a plurality of pieces of to-be-detected network traffic;
aggregating the plurality of pieces of to-be-detected network traffic, and encapsulating the plurality of pieces of to-be-detected network traffic into one piece of detection traffic; and
transmitting the detection traffic to a traffic detection device, the traffic detection device being configured to detect the detection traffic to obtain detection results corresponding to the plurality of pieces of to-be-detected network traffic.

According to some embodiments, a computer-readable storage medium is provided. The computer-readable storage medium is configured to store a computer program which, when run by a computer device, causes the computer device to perform the data processing method according to foregoing embodiments.

According to some embodiments, a computer program product is provided, including a computer program. The computer program is stored in the computer-readable storage medium. A processor of a computer device reads the computer program from the computer-readable storage medium, and the processor executes the computer program to cause the computer device to perform the method provided in some embodiments.

The terms “first”, “second”, “third”, “fourth”, and the like (if any) and the foregoing accompanying drawings are used for distinguishing similar objects and are not necessarily used for describing a particular order or sequence. Data used in this way is exchangeable in a proper case so that some embodiments described herein can be implemented in an order different from the order shown or described herein. The terms “include”, “have” and any other variants mean to cover the non-exclusive inclusion, for example, a process, method, system, product, or device that includes a list of operations or units is not limited to those expressly listed operations or units, but may include other operations or units not expressly listed or inherent to such a process, method, product, or device.

In the several embodiments provided in some embodiments, the disclosed system, apparatus, and method may be implemented in other manners. For example, the unit division is a logical function division and may be other division during actual implementation. For example, a plurality of units or assemblies may be combined or integrated into another system. The couplings, direct couplings, or communication connections shown or discussed with respect to each other may be indirect couplings or communication connections through some interfaces, apparatuses, or units, and may be electrical, mechanical, or otherwise.

According to some embodiments, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

When the integrated unit is implemented in the form of a software functional unit and sold or used as an independent product, the integrated unit may be stored in a computer-readable storage medium. Based on such an understanding, some embodiments, or the part contributing to the related art, or all or some of some embodiments may be implemented in the form of a software product. The computer software product is stored in a storage medium and includes several instructions for causing a computer device (which may be a computer, a server, a network device, or the like) to perform all or some of the operations of the methods according to some embodiments. The foregoing storage medium includes: various media capable of storing program code, such as a USB flash drive, a mobile hard disk, a read-only memory (ROM), a RAM, a magnetic disk, or an optical disc.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data processing method, performed by a computer device, comprising:
acquiring network traffic data;
performing information extraction on the network traffic data;
obtaining target information corresponding to the network traffic data, a volume of the target information being less than a volume of the network traffic data;
transmitting the target information to a traffic detection device; and
obtaining a detection result, from the traffic detection device, corresponding to the network traffic data.

2. The method according to claim 1,
wherein the network traffic data comprises n pieces of network traffic data, n being an integer greater than 1, and
wherein the transmitting the target information to a traffic detection device comprises:
aggregating the target information corresponding to the n pieces of network traffic data;
obtaining and transmitting aggregation information to the traffic detection device; and
obtaining a detection result from the traffic detection device.

3. The method according to claim 2,
wherein before the aggregating target information corresponding to the n pieces of network traffic data, the method further comprises:
writing the target information into cache addresses; and
wherein the aggregating target information corresponding to the n pieces of network traffic data comprises:
aggregating the target information into the cache addresses; and
wherein the obtaining and transmitting aggregation information to the traffic detection device comprises:
reading the aggregation information from the cache addresses, and transmitting the aggregation information to the traffic detection device.

4. The method according to claim 3,
wherein the cache addresses comprise a first cache address and a second cache address, the volume of the target information is a preset data length, and
wherein the writing the target information into cache addresses comprises:
writing, based on determining that a remaining cache length of the first cache address is greater than or equal to the preset data length, an i-th piece of target information that corresponds to an i-th piece of network traffic data into the first cache address, wherein i is an integer greater than or equal to 2 and less than or equal to n; and
wherein the first cache address stores an (i−1)-th piece of target information corresponding to an (i−1)-th piece of network traffic data;
writing the i-th piece of target information into the second cache address, based on determining that the remaining cache length of the first cache address is less than the preset data length; and
writing n pieces of target information into the cache addresses.

5. The method according to claim 4,
wherein a maximum cache length of the first cache address comprises m preset data lengths, m being an integer greater than 1,
wherein the determining that a remaining cache length of the first cache address is greater than or equal to the preset data length comprises:
determining that the remaining cache length of the first cache address is greater than or equal to the preset data length based on i being less than or equal to m; and
wherein the determining that the remaining cache length of the first cache address is less than the preset data length comprises:
determining that the remaining cache length of the first cache address is less than the preset data length based on i being greater than or equal to m.

6. The method according to claim 4,
wherein the first cache address corresponds to a first child node, the second cache address corresponds to a second child node, and the first child node and the second child node both correspond to a parent node;
wherein the parent node receives the i-th piece of target information among nodes comprised in a binary tree, and
wherein the writing the i-th piece of target information into the first cache address comprises:
determining a maximum cache length of the first child node based on the number of layers of the parent node in the binary tree and a maximum cache length of the first cache address,
wherein the maximum cache length of the first cache address comprises m preset data lengths, and m is an integer greater than 1;
determining that a length of historical information transmitted through the first child node is less than the maximum cache length of the first child node;
transmitting the i-th piece of target information to the first child node; and
writing the i-th piece of target information into the first cache address through the first child node;
wherein the writing the i-th piece of target information into the second cache address comprises:
determining that the remaining cache length of the first cache address is less than the preset data length based on determining the length of the historical information through the first child node being equal to the maximum cache length of the first child node; and
transmitting the i-th piece of target information to the second child node, and
writing the i-th piece of target information into the second cache address through the second child node.

7. The method according to claim 3, wherein the aggregating the target information into the cache addresses comprises:
determining a cache address that stores m pieces of target information among the first cache address;
determining the second cache address as a target cache address;
aggregating, based on the m pieces of target information, the target information corresponding to the n pieces of network traffic data.

8. The method according to claim 1, wherein the acquiring network traffic data comprises:
acquiring transmission network traffic;
parsing the transmission network traffic;
obtaining a type identifier of the transmission network traffic; and
determining, based on the type identifier being a replication identifier, the transmission network traffic as the network traffic data.

9. The method according to claim 8, wherein the acquiring transmission network traffic comprises:
acquiring initial network traffic, a type identifier of the initial network traffic being a business identifier;
performing multicast replication on the initial network traffic;
obtaining replicated network traffic, a type identifier of the replicated network traffic being the replication identifier; and
determining the initial network traffic and the replicated network traffic as the transmission network traffic.

10. The method according to claim 8, wherein the acquiring transmission network traffic comprises:
acquiring initial network traffic;
determining the initial network traffic as the transmission network traffic, a type identifier of the initial network traffic being a business identifier;
replicating, based on determining that the type identifier of the transmission network traffic being the business identifier, the transmission network traffic; and
determining replicated network traffic as the transmission network traffic, a type identifier of the replicated network traffic being the replication identifier.

11. The method according to claim 9, wherein the acquiring initial network traffic comprises:
sampling, in a process of transmitting network traffic by a first device to a second device, transmitted network traffic according to a sampling ratio; and
obtaining the initial network traffic.

12. A data processing apparatus, comprising:
at least one memory configured to store program code; and
at least one processor configured to read the program code and operate as instructed by the program code, the program code comprising:
acquisition code configured to cause at least one of the at least one processor to acquire network traffic data;
extraction code configured to cause at least one of the at least one processor to perform information extraction on the network traffic data;
obtaining code configured to cause at least one of the at least one processor to obtain target information corresponding to the network traffic data, a volume of the target information being less than a volume of the network traffic data; and
transmission code configured to cause at least one of the at least one processor to transmit the target information to a traffic detection device, and obtain a detection result, from the traffic detection device, corresponding to the network traffic data.

13. The apparatus according to claim 12,
wherein the network traffic data comprises n pieces of network traffic data, n being an integer greater than 1, and
wherein the transmission code is further configured to cause at least one of the at least one processor to:
aggregate the target information corresponding to the n pieces of network traffic data;
obtain and transmit aggregation information to the traffic detection device; and
obtain a detection result from the traffic detection device.

14. The apparatus according to claim 13,
wherein the program code is further configured to cause at least one of the at least one processor to:
write the target information into cache addresses, before aggregating target information corresponding to the n pieces of network traffic data; and
wherein the transmission code is further configured to cause at least one of the at least one processor to:
aggregate the target information into the cache addresses;
read the aggregation information from the cache addresses; and
transmit the aggregation information to the traffic detection device.

15. The apparatus according to claim 14,
wherein the cache addresses comprise a first cache address and a second cache address, the volume of the target information is a preset data length, and
wherein the program code is further configured to cause at least one of the at least one processor to:
write, based on determining that a remaining cache length of the first cache address is greater than or equal to the preset data length, an i-th piece of target information that corresponds to an i-th piece of network traffic data into the first cache address,
wherein i is an integer greater than or equal to 2 and less than or equal to n; and
wherein the first cache address stores an (i−1)-th piece of target information corresponding to an (i−1)-th piece of network traffic data;
write the i-th piece of target information into the second cache address, based on determining that the remaining cache length of the first cache address is less than the preset data length; and
write n pieces of target information into the cache addresses.

16. The apparatus according to claim 15,
wherein a maximum cache length of the first cache address comprises m preset data lengths, m being an integer greater than 1,
wherein the program code is further configured to cause at least one of the at least one processor to:
determine that the remaining cache length of the first cache address is greater than or equal to the preset data length based on i being less than or equal to m; and
determine that the remaining cache length of the first cache address is less than the preset data length based on i being greater than or equal to m.

17. The apparatus according to claim 15,
wherein the first cache address corresponds to a first child node, the second cache address corresponds to a second child node, and the first child node and the second child node both correspond to a parent node;
wherein the parent node receives the i-th piece of target information among nodes comprised in a binary tree, and
wherein the program code is further configured to cause at least one of the at least one processor to:
determine a maximum cache length of the first child node based on the number of layers of the parent node in the binary tree and a maximum cache length of the first cache address, wherein the maximum cache length of the first cache address comprises m preset data lengths, and m is an integer greater than 1;
determine that a length of historical information transmitted through the first child node is less than the maximum cache length of the first child node;
transmit the i-th piece of target information to the first child node;
write the i-th piece of target information into the first cache address through the first child node;
determine that the remaining cache length of the first cache address is less than the preset data length based on determining the length of the historical information through the first child node being equal to the maximum cache length of the first child node;
transmit the i-th piece of target information to the second child node, and
write the i-th piece of target information into the second cache address through the second child node.

18. The apparatus according to claim 14, wherein the program code is further configured to cause at least one of the at least one processor to:
determine a cache address that stores m pieces of target information among the first cache address;
determine the second cache address as a target cache address; and
aggregate, based on the m pieces of target information, the target information corresponding to the n pieces of network traffic data.

19. The apparatus according to claim 12, wherein the acquisition code is further configured to cause at least one of the at least one processor to:
acquire transmission network traffic;
parse the transmission network traffic;
obtain a type identifier of the transmission network traffic; and
determine, based on the type identifier being a replication identifier, the transmission network traffic as the network traffic data.

20. A non-transitory computer-readable storage medium, storing computer code which, when executed by at least one processor, causes the at least one processor to at least:
acquire network traffic data;
perform information extraction on the network traffic data;
obtain target information corresponding to the network traffic data, a volume of the target information being less than a volume of the network traffic data;
transmit the target information to a traffic detection device; and
obtain a detection result, from the traffic detection device, corresponding to the network traffic data.
